(19) United States
(12) Patent Application Publication
(10) Pub. No.: US 2025/0285086 A1
(43) Pub. Date: Sep. 11, 2025

(54) MAINTENANCE SCHEDULING AND OPTIMIZATION SYSTEM FOR CONNECTED EQUIPMENT

(71) Applicant: Tyco Fire & Security GmbH, Neuhausen am Rheinfall (CH)

(72) Inventors: Sankarsan Sinha, Barasat (IN); Parag Madhukar Datir, Pune (IN); Nina Vanessa Li, Düsseldorf (DE)

(21) Appl. No.: 19/074,081

(22) Filed: Mar. 7, 2025

(30) Foreign Application Priority Data
Mar. 8, 2024 (IN) 202421016822

(51) Int. Cl. G06Q 10/1093; G06Q 10/0631

(52) U.S. Cl. CPC G06Q 10/1097; G06Q 10/063114

(57) ABSTRACT

A method includes obtaining equipment operating data, detecting or predicting a plurality of faults in the operation of the plurality of devices of equipment based on the equipment operating data, determining service provider resources available to perform service on the equipment, the service provider resources including remote service provider resources and on-site service provider resources, generating a service schedule comprising a plurality of service events based on the plurality of faults and the service provider resources, the plurality of service events including a remote service event using the remote service provider resources and an on-site service event using the on-site service provider resources, wherein the service schedule is generated by performing an optimization subject to constraints based on the service provider resources and the plurality of faults and initiating an automated action to perform the plurality of service events at corresponding times and locations defined by the service schedule.

### CROSS-REFERENCE TO RELATED APPLICATIONS

This application claims priority to and the benefit of Indian Provisional Patent Application No. 202421016822, filed Mar. 8, 2024, which is incorporated herein by reference in its entirety.

### BACKGROUND

Equipment installed at various equipment sites (e.g., building sites, work sites, industrial sites, mining sites, etc.) have varying maintenance requirements which require a wide variety of resources to service properly. For example, HVAC equipment, oil and gas mining equipment, and IT networking equipment may have different service needs and may require different expertise to diagnose and resolve faults accurately and efficiently. Further, the equipment may require different tools or parts and may be distributed across many different geographic locations. Some equipment may be more critical than others or may result in more costly problems when not operating properly. Faults in equipment can occur at any time and may be unpredictable in some cases. It can be challenging to generate a suitable maintenance schedule in view of changing service needs and varying resources required to perform service on such equipment.

### SUMMARY

At least one embodiment relates to a method. The method may include obtaining equipment operating data characterizing operation of a plurality of devices of equipment distributed across a plurality of equipment sites. The method may include detecting or predicting a plurality of faults in the operation of the plurality of devices of equipment based on the equipment operating data. The method may include determining service provider resources available to perform service on the plurality of devices of equipment, the service provider resources comprising remote service provider resources and on-site service provider resources. The method may include generating a service schedule comprising a plurality of service events based on the plurality of faults and the service provider resources, the plurality of service events comprising at least one remote service event using the remote service provider resources and at least one on-site service event using the on-site service provider resources, wherein the service schedule is generated by performing an optimization subject to a set of constraints based on the service provider resources and the plurality of faults. The method may include initiating an automated action to perform the plurality of service events at corresponding times and locations defined by the service schedule.

In some embodiments, the plurality of equipment sites may include a building site and the equipment may include HVAC equipment located at the building site.

In some embodiments, initiating the automated action may include causing one or more service technicians to perform the plurality of events activities defined by the service schedule.

In some embodiments, initiating the automated action may include distributing at least a portion of the service schedule to a plurality of technicians assigned to the plurality of service events.

In some embodiments, generating the service schedule may include classifying the plurality of faults as either (i) remote fix faults capable of being fixed remotely by remote service technicians or (ii) on-site fix faults requiring on-site service technicians to travel to the equipment sites to perform the plurality of service events.

In some embodiments, the automated action may include taking action to resolve the fault remotely.

In some embodiments, detecting or predicting the plurality of faults may include gathering additional data from an equipment site to diagnose a root cause of a detected or predicted fault.

In some embodiments, the set of constraints may include a limit or penalty based on a travel time or travel distance between the plurality of service events in the service schedule.

In some embodiments, the optimization may include optimizing an objective function that quantifies a total value of the plurality of service events based on at least one of corresponding criticalities of the plurality of faults or corresponding amounts of time elapsed between times at which the plurality of faults are detected and the times defined by the plurality of service events.

In some embodiments, the service provider resources include times of availability and expertise of a plurality of service technicians. In some embodiments, the constraints may include amounts of time and expertise required to perform the corresponding service events.

In some embodiments, the service provider resources vary by geographic region and indicate at least one of different numbers of service technicians, different levels of expertise of the service technicians, or different tools or parts available to the service technicians based on the geographic region in which the fault is detected or predicted.

In some embodiments, the service provider resources may include one or more vehicles or tools used to perform the plurality of service events. In some embodiments, performing the optimization includes assigning the one or more vehicles or tools to the plurality of service events.

At least one embodiment relates to a method. The method may include obtaining equipment operating data characterizing operation of equipment located at an equipment site. The method may include detecting or predicting a fault in the operation of the equipment based on the equipment operating data. The method may include generating a service schedule comprising a remote service event based on the fault, the remote service event assigning a remote service technician to attempt to fix the fault remotely. The method may include updating the service schedule to replace the remote service event with an on-site service event in response to the remote service event failing to fix the fault. The method may include providing a report to an on-site service technician prior to a time defined by the on-site service event, the report identifying a history of prior service events for the equipment including the remote service event. The method may include initiating an automated action to perform the on-site service event at the location of the equipment at the time defined by the service schedule.

In some embodiments, the equipment site includes a building site and the equipment includes HVAC equipment located at the building site.

In some embodiments, initiating the automated action includes causing one or more service technicians to perform the on-site service event defined by the service schedule.

In some embodiments, initiating the automated action includes distributing at least a portion of the service schedule to a plurality of technicians assigned to the plurality of service events.

In some embodiments, detecting or predicting the fault includes gathering additional data from an equipment site to diagnose a root cause of a detected or predicted fault.

In some embodiments, the method further includes optimizing an objective function that quantifies a total value of the plurality of service events based on at least one of corresponding criticalities of the plurality of faults or corresponding amounts of time elapsed between times at which the fault is detected and the times defined by the on-site service event.

At least one embodiment relates to a method. The method may include obtaining a first set of equipment operating data characterizing operation of equipment located at an equipment site. The method may include determining a first set of service provider resources required to perform service on the equipment based on the first set of equipment operating data. The method may include generating a service schedule comprising a first service event which uses the first set of service provider resources to perform the service on the equipment. The method may include obtaining a second set of equipment operating data characterizing the operation of equipment after generating the service schedule and before the first service event. The method may include updating the service schedule to replace the first service event with a second service event which uses a second set of service provider resources to perform the service on the equipment in response to the second set of equipment operating data indicating different service requirements than the first set of equipment operating data. The method may include initiating an automated action to perform service on the equipment in accordance with the second service event.

In some embodiments, the equipment site includes a building site and the equipment include HVAC equipment located at the building site.

In some embodiments, initiating the automated action includes causing one or more service technicians to perform the plurality of service activities defined by the service schedule.

In some embodiments, initiating the automated action includes distributing at least a portion of the service schedule to a plurality of technicians assigned to the plurality of service events.

In some embodiments, generating the service schedule includes classifying the plurality of faults as either remote fix faults capable of being fixed remotely by remote service technicians or on-site fix faults requiring on-site service technicians to travel to the equipment sites to perform the service activities.

In some embodiments, the automated action includes taking action to resolve the fault remotely.

In some embodiments, the method further includes optimizing an objective function that quantifies a total value of the plurality of service events based on at least one of corresponding criticalities of the plurality of faults or corresponding amounts of time elapsed between times at which the plurality of faults are detected and the times defined by the plurality of service events.

In some embodiments, the service provider resources include times of availability and expertise of a plurality of service technicians.

In some embodiments, the service provider resources vary by geographic region and indicate at least one of different numbers of service technicians, different levels of expertise of the service technicians, or different tools or parts available to the service technicians based on the geographic region in which the fault is detected or predicted.

In some embodiments, the service provider resources comprise one or more vehicles or tools used to perform the plurality of service activities. In some embodiments, performing the optimization includes assigning the one or more vehicles or tools to the plurality of service events.

In some embodiments, the second set of equipment operating data characterizes operation of second equipment, the second equipment different from the first equipment. In some embodiments, the method further includes updating the service schedule to replace the first service event with a second service event which uses a second set of service provider resources to perform the service on the equipment in response to the second set of equipment operating data indicating higher priority service requirements associated with the second equipment.

At least one embodiment relates to a method. The method may include obtaining a first set of equipment operating data characterizing operation of first equipment located at an equipment site. The method may include determining a first set of service provider resources required to perform service on the equipment based on the first set of equipment operating data. The method may include generating a service schedule comprising a first service event which uses the first set of service provider resources to perform the service on the equipment. The method may include obtaining a second set of equipment operating data characterizing operation of second equipment after generating the service schedule and before the first service event. The method may include updating the service schedule to replace the first service event with a second service event which uses a second set of service provider resources to perform the service on the first equipment in response to the second set of equipment operating data indicating higher priority service requirements associated with the second equipment. The method may include initiating an automated action to perform service on the first equipment in accordance with the second service event.

In some embodiments, the equipment site includes a building site and the equipment include HVAC equipment located at the building site.

In some embodiments, initiating the automated action includes causing one or more service technicians to perform the plurality of service activities defined by the service schedule.

In some embodiments, initiating the automated action includes distributing at least a portion of the service schedule to a plurality of technicians assigned to the plurality of service events.

In some embodiments, generating the service schedule includes classifying the plurality of faults as either remote fix faults capable of being fixed remotely by remote service technicians or on-site fix faults requiring on-site service technicians to travel to the equipment sites to perform the service activities.

In some embodiments, the automated action includes taking action to resolve the fault remotely.

In some embodiments, the method includes optimizing an objective function that quantifies a total value of the plurality of service events based on at least one of (i) corresponding criticalities of the plurality of faults or (ii) corresponding amounts of time elapsed between times at which the plurality of faults are detected and the times defined by the plurality of service events.

In some embodiments, the service provider resources include times of availability and expertise of a plurality of service technicians.

In some embodiments, the service provider resources vary by geographic region and indicate at least one of different numbers of service technicians, different levels of expertise of the service technicians, or different tools or parts available to the service technicians based on the geographic region in which the fault is detected or predicted.

In some embodiments, the service provider resources comprise one or more vehicles or tools used to perform the plurality of service activities. In some embodiments, performing the optimization includes assigning the one or more vehicles or tools to the plurality of service events.

At least one aspect of this disclosure relates to a method. The method may include obtaining equipment operating data characterizing operation of equipment located at an equipment site. The method may include detecting or predicting a fault in the operation of the equipment based on the equipment operating data. The method may include executing a virtual agent at the equipment site to gather additional data for use in diagnosing a cause of the fault or repairing the fault. The method may include providing the additional data from the equipment site to a remote service technician via the virtual agent. The method may include initiating an automated action to perform service on the equipment based on the additional data provided via the virtual agent.

In some embodiments, the equipment site includes a building site and the equipment include HVAC equipment located at the building site.

In some embodiments, the automated action includes taking action to resolve the fault remotely.

In some embodiments, detecting or predicting the plurality of faults includes gathering additional data from an equipment site to diagnose a root cause of a detected or predicted fault.

In some embodiments, executing the automated action includes providing instructions to the virtual agent and executing the instructions by the virtual agent at the equipment site.

### BRIEF DESCRIPTION OF THE DRAWINGS

FIG. 1 is a drawing of a building equipped with a heating, ventilation, and/or air conditioning (HVAC) system, according to an exemplary embodiment.

FIG. 2 is a schematic diagram of a waterside system which can be used in conjunction with the building of FIG. 1, according to some embodiments.

FIG. 3 is a schematic diagram of an airside system which can be used in conjunction with the building of FIG. 1, according to some embodiments.

FIG. 4 is a block diagram of a building management system (BMS) which can be used to monitor and control the building of FIG. 1, according to some embodiments.

FIG. 5 is a block diagram of another BMS which can be used to monitor and control the building of FIG. 1 and includes a maintenance scheduling and optimization system, according to some embodiments.

FIG. 6A is a block diagram of another BMS including the maintenance scheduling and optimization system for optimizing service schedules, according to some embodiments.

FIG. 6B is a block diagram of another BMS including the maintenance scheduling and optimization system for optimizing service schedules, according to some embodiments.

FIG. 7 is a block diagram of a maintenance scheduling and optimization system for connected equipment, according to some embodiments.

FIG. 8 illustrates an equipment report which can be generated by the maintenance scheduling and optimization system of FIG. 7, according to some embodiments.

FIG. 9 illustrates an equipment report which can be generated by the maintenance scheduling and optimization system of FIG. 7, according to some embodiments.

FIG. 10 illustrates an equipment report which can be generated by the maintenance scheduling and optimization system of FIG. 7, according to some embodiments.

FIG. 11 illustrates an equipment report which can be generated by the maintenance scheduling and optimization system of FIG. 7, according to some embodiments.

FIG. 12 illustrates an equipment report which can be generated by the maintenance scheduling and optimization system of FIG. 7, according to some embodiments.

FIG. 13 illustrates an equipment report which can be generated by the maintenance scheduling and optimization system of FIG. 7, according to some embodiments.

FIG. 14 illustrates an equipment report which can be generated by the maintenance scheduling and optimization system of FIG. 7, according to some embodiments.

FIG. 15 illustrates a user interface which can include the data included in the equipment report, according to some embodiments.

FIG. 16 is a flow diagram illustrating a method of optimizing service schedules which can be performed by the maintenance scheduling and optimization system of FIG. 7, according to some embodiments.

FIG. 17 is a flow diagram illustrating another method of optimizing service schedules which can be performed by the maintenance scheduling and optimization system of FIG. 7, according to some embodiments.

FIG. 18 is a flow diagram illustrating another method of optimizing service schedules which can be performed by the maintenance scheduling and optimization system of FIG. 7, according to some embodiments.

FIG. 19 is a flow diagram illustrating another method of optimizing service schedules which can be performed by the maintenance scheduling and optimization system of FIG. 7, according to some embodiments.

FIG. 20 is a flow diagram illustrating another method of optimizing service schedules which can be performed by the maintenance scheduling and optimization system of FIG. 7, according to some embodiments.

### DETAILED DESCRIPTION

Referring generally to the FIGURES, systems and methods are provided for an integrated global chiller maintenance scheduling system with virtual inspection report optimization.

By analyzing demand forecasts and historical work metrics, the present disclosure may enable efficient allocation of branch technicians to different sites. This may cause or ensure that resources are utilized optimally, for example by minimizing downtime and non-productive time (e.g., travel time) which may help in reducing carbon emissions, and maximizing productivity.

Effective capacity planning can aid in reducing unnecessary travel time and expenses associated with technicians commuting between sites. By assigning technicians to sites closer to their region/home location or considering transport work hours, the systems and methods described herein can lower operational costs.

By aligning technician capacity with demand at various sites, the systems and methods described herein may help to maintain or improve service levels. The systems and methods described herein may help to provide early or on-time reach to customers. This may lead to improved equipment operation, fewer equipment failures, less equipment downtime, and more efficient equipment operation as a result of performing service on equipment quickly and efficiently.

Additionally, incorporating demand forecasting and historical work hour data may enhance the accuracy of capacity planning. This may allow businesses to better anticipate and respond to fluctuations in demand, leading to smoother operations.

A lack of technician preparedness due to inadequate access to site information can result in delays, errors, and safety risks. The present disclosure improves technician preparedness by providing technicians with detailed virtual inspection reports, previous history and predictive faults/issues at site and educational materials, thus enhancing their knowledge and preparedness before entering the field.

The systems and methods described herein address the challenge of optimizing preventive maintenance scheduling for chiller units across global regions, and enable timely inspections and maintenance activities while efficiently allocating resources.

By integrating virtual inspection reports with onsite technician schedules and considering resource constraints, the disclosure streamlines the scheduling process. This meets the need for a systematic and efficient approach to chiller unit maintenance, reducing downtime, minimizing operational costs, and improving overall reliability. Additionally, by providing branches with clear resource requirements, the disclosure enhances coordination and planning, ultimately meeting the critical need for effective chiller unit maintenance in commercial and industrial settings.

The systems and methods described herein are designed to be scalable and adaptable to varying organizational structures, site configurations, and maintenance requirements. The disclosure can accommodate changes in business needs, technological advancements, and operational priorities, enabling long-term viability and relevance in a rapidly evolving industry landscape.

The systems and methods described herein provide several advantages and improvements to existing technology in the technical fields of building management systems and equipment maintenance systems. For example, the maintenance scheduling and optimization system described herein can determine the root causes of various faults in devices equipment and identify the specific activities or fixes needed to repair the faults. The maintenance scheduling and optimization system can classify some faults as capable of being repaired remotely or automatically (e.g., by distributing updated software, control logic, or firmware to the devices via a communications network, automatically restarting the devices or restoring the devices to factory settings, causing the devices to operate in a different mode or using an alternative control strategy, etc.), whereas other faults can be classified as requiring on-site service from a human technician (e.g., repairing or replacing a broken part, cleaning a dirty fluid conduit or filter, replacing physical wiring, installing a new hardware component, etc.). The maintenance scheduling and optimization system can perform or initiated automated actions to cause the remote-fix faults to be repaired automatically or remotely without requiring an on-site visit from a service technician or requiring human intervention. Such automated diagnostics and repair may free-up service provider resources by allowing service providers to focus on the types of faults that require on-site service or repair. This ensures that the service provider resources are allocated efficiently and improves the operation of the equipment by ensuring that repairs are quick and effective.

The maintenance scheduling and optimization system can also optimally schedule service events to ensure that the service provider resources are used efficiently (e.g., by reducing travel time between site visits, ensuring service providers have the appropriate tools, parts, or materials needed for service events, etc.) and allocated toward repairing the most significant or important faults first. As new faults are detected or received, the maintenance scheduling and optimization system can automatically update or reoptimize the schedule of service events to ensure high priority faults are addressed before low priority faults and that the schedule of service events remains efficient in view of the updated set of faults. This improves the operation of the equipment as a whole by addressing or resolving the most impactful faults first and provides various improvements such as reduced energy consumption, reduced downtime, etc.

Advantageously, the maintenance scheduling and optimization system described herein optimally allocates service provider resources and makes use of remote diagnostics, automatic repairs, and remote fixes when possible to ensure that faults in devices of equipment are repaired quickly and efficiently while minimizing or reducing the need for human intervention. This reduces the amount of time that the devices of equipment operate in a fault state or are rendered inoperable by unrepaired faults. The repaired devices of equipment may operate more efficiently and reliably, which leads to less energy consumption, reduced carbon emissions, less downtime, and other technical improvements. These and other improvements and advantages are described in detail throughout the present disclosure.

### Building HVAC Systems and Building Management Systems

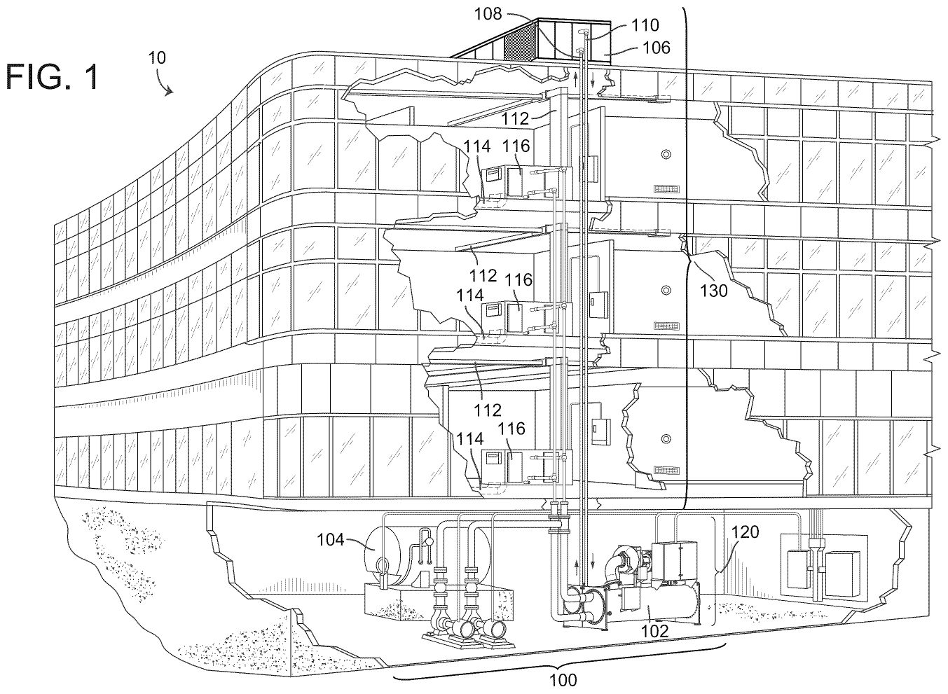

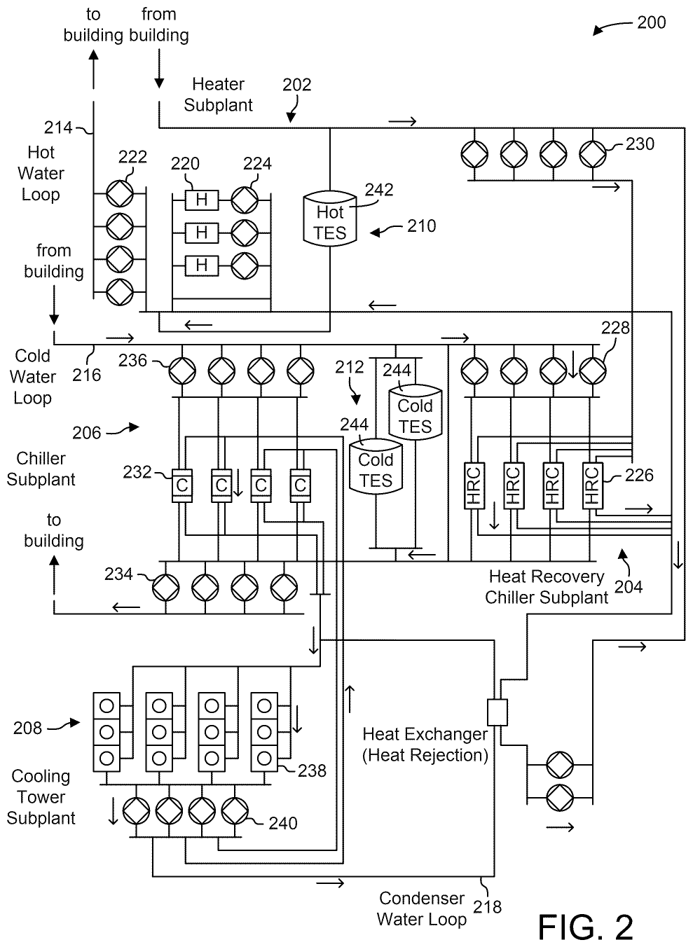

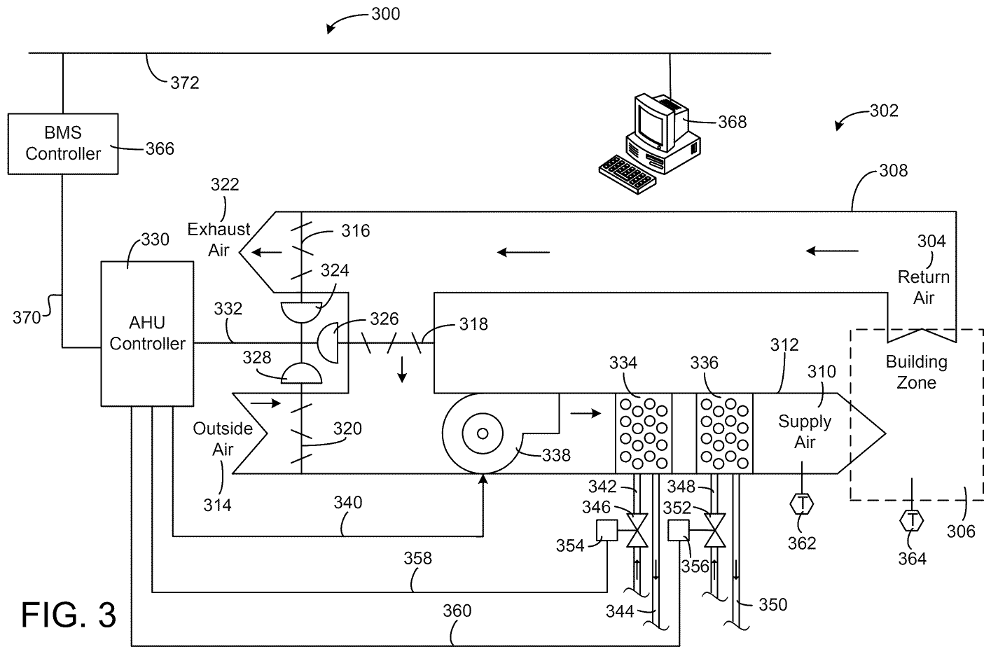

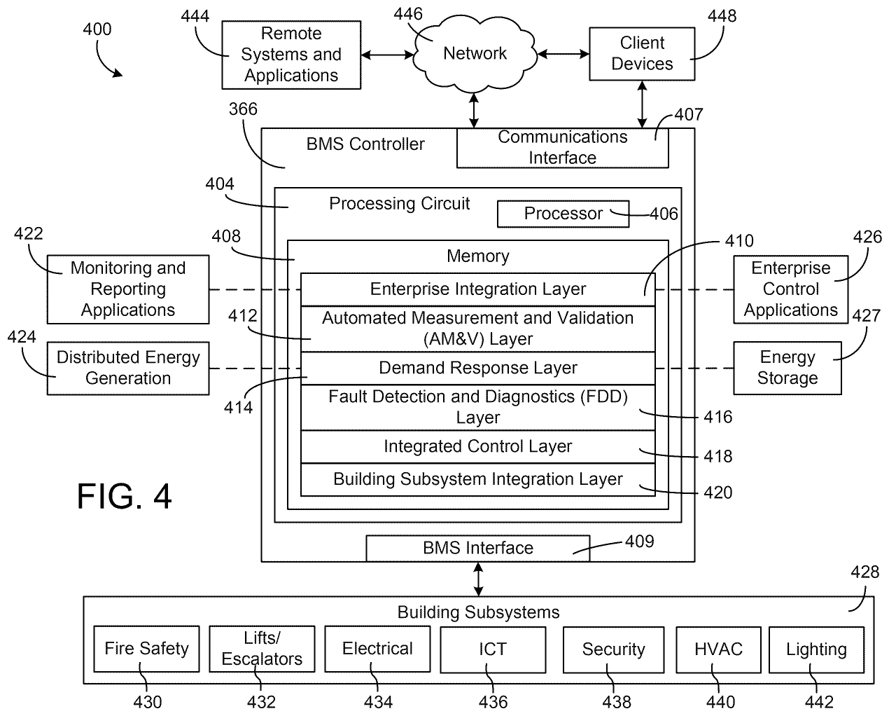

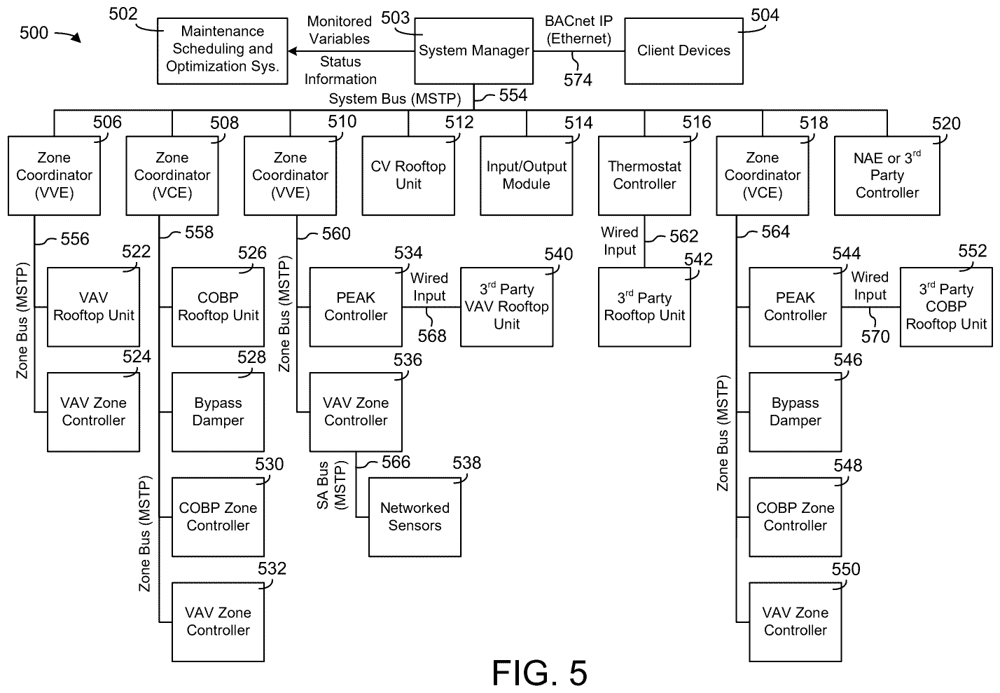

Referring now to FIGS. 1-5, several building management systems (BMS) and HVAC systems in which the systems and methods of the present disclosure can be implemented are shown, according to some embodiments. In brief overview, FIG. 1 shows a building 10 equipped with a HVAC system 100. FIG. 2 is a block diagram of a waterside system 200 which can be used to serve building 10. FIG. 3 is a block diagram of an airside system 300 which can be used to serve building 10. FIG. 4 is a block diagram of a BMS which can be used to monitor and control building 10. FIG. 5 is a block diagram of another BMS which can be used to monitor and control building 10.

### Building 10 and HVAC System 100

Referring particularly to FIG. 1, a perspective view of building 10 is shown. Building 10 is served by a BMS. A BMS is, in general, a system of devices configured to control, monitor, and manage equipment in or around a building or building area. A BMS can include, for example, a HVAC system, a security system, a lighting system, a fire alerting system, any other system that is capable of managing building functions or devices, or any combination thereof.

The BMS that serves building 10 includes an HVAC system 100. HVAC system 100 can include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide a heated or chilled fluid to an air handling unit of airside system 130. Airside system 130 may use the heated or chilled fluid to heat or cool an airflow provided to building 10. An exemplary waterside system and airside system which can be used in HVAC system 100 are described in greater detail with reference to FIGS. 2 and 3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 can be located in or around building 10 (as shown in FIG. 1) or at an offsite location such as a central plant (e.g., a chiller plant, a steam plant, a heat plant, etc.). The working fluid can be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 can be transported to AHU 106 via piping 108.

AHU 106 may place the working fluid in a heat exchange relationship with an airflow passing through AHU 106 (e.g., via one or more stages of cooling coils and/or heating coils). The airflow can be, for example, outside air, return air from within building 10, or a combination of both. AHU 106 may transfer heat between the airflow and the working fluid to provide heating or cooling for the airflow. For example, AHU 106 can include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (i.e., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 can include dampers or other flow control elements that can be operated to control an amount of the supply airflow provided to individual zones of building 10. In other embodiments, airside system 130 delivers the supply airflow into one or more zones of building 10 (e.g., via air supply ducts 112) without using intermediate VAV units 116 or other flow control elements. AHU 106 can include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve setpoint conditions for the building zone.

### Waterside System 200

Referring now to FIG. 2, a block diagram of a waterside system 200 is shown, according to some embodiments. In various embodiments, waterside system 200 may supplement or replace waterside system 120 in HVAC system 100 or can be implemented separate from HVAC system 100. When implemented in HVAC system 100, waterside system 200 can include a subset of the HVAC devices in HVAC system 100 (e.g., boiler 104, chiller 102, pumps, valves, etc.) and may operate to supply a heated or chilled fluid to AHU 106. The HVAC devices of waterside system 200 can be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve thermal energy loads (e.g., hot water, cold water, heating, cooling, etc.) of a building or campus. For example, heater subplant 202 can be configured to heat water in a hot water loop 214 that circulates the hot water between heater subplant 202 and building 10. Chiller subplant 206 can be configured to chill water in a cold water loop 216 that circulates the cold water between chiller subplant 206 building 10. Heat recovery chiller subplant 204 can be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air can be delivered to individual zones of building 10 to serve thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) can be used in place of or in addition to water to serve thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 can include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves can be integrated with the pumps or positioned upstream or downstream of the pumps to control the fluid flows in waterside system 200. In various embodiments, waterside system 200 can include more, fewer, or different types of devices and/or subplants based on the particular configuration of waterside system 200 and the types of loads served by waterside system 200.

### Airside System 300

Referring now to FIG. 3, a block diagram of an airside system 300 is shown, according to some embodiments. In various embodiments, airside system 300 may supplement or replace airside system 130 in HVAC system 100 or can be implemented separate from HVAC system 100. When implemented in HVAC system 100, airside system 300 can include a subset of the HVAC devices in HVAC system 100 (e.g., AHU 106, VAV units 116, ducts 112-114, fans, dampers, etc.) and can be located in or around building 10. Airside system 300 may operate to heat or cool an airflow provided to building 10 using a heated or chilled fluid provided by waterside system 200.

In FIG. 3, airside system 300 is shown to include an economizer-type air handling unit (AHU) 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 can be configured to operate exhaust air damper 316, mixing damper 318, and outside air damper 320 to control an amount of outside air 314 and return air 304 that combine to form supply air 310. Any return air 304 that does not pass through mixing damper 318 can be exhausted from AHU 302 through exhaust damper 316 as exhaust air 322.

Each of dampers 316-320 can be operated by an actuator. For example, exhaust air damper 316 can be operated by actuator 324, mixing damper 318 can be operated by actuator 326, and outside air damper 320 can be operated by actuator 328. Actuators 324-328 may communicate with an AHU controller 330 via a communications link 332. Actuators 324-328 may receive control signals from AHU controller 330 and may provide feedback signals to AHU controller 330. Feedback signals can include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that can be collected, stored, or used by actuators 324-328. AHU controller 330 can be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 can be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 can be positioned along piping 342 or piping 344 to control a flow rate of the chilled fluid through cooling coil 334. In some embodiments, cooling coil 334 includes multiple stages of cooling coils that can be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 can be positioned along piping 348 or piping 350 to control a flow rate of the heated fluid through heating coil 336. In some embodiments, heating coil 336 includes multiple stages of heating coils that can be independently activated and deactivated (e.g., by AHU controller 330, by BMS controller 366, etc.) to modulate an amount of heating applied to supply air 310.

Each of valves 346 and 352 can be controlled by an actuator. For example, valve 346 can be controlled by actuator 354 and valve 352 can be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a building management system (BMS) controller 366 and a client device 368. BMS controller 366 can include one or more computer systems (e.g., servers, supervisory controllers, subsystem controllers, etc.) that serve as system level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 can be separate (as shown in FIG. 3) or integrated. In an integrated implementation, AHU controller 330 can be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that can be used by BMS controller 366 to monitor or control a variable state or condition within building zone 306.

Client device 368 can include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 can be a computer workstation, a client terminal, a remote or local interface, or any other type of user interface device. Client device 368 can be a stationary terminal or a mobile device. For example, client device 368 can be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

### Building Management System 400

Referring now to FIG. 4, a block diagram of a building management system (BMS) 400 is shown, according to some embodiments. BMS 400 can be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, a HVAC subsystem 440, a lighting subsystem 442, a lift/escalators subsystem 432, and a fire safety subsystem 430. In various embodiments, building subsystems 428 can include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2 and 3.

Each of building subsystems 428 can include any number of devices, controllers, and connections for completing its individual functions and control activities. HVAC subsystem 440 can include many of the same components as HVAC system 100, as described with reference to FIGS. 1-3. For example, HVAC subsystem 440 can include a chiller, a boiler, any number of air handling units, economizers, field controllers, supervisory controllers, actuators, temperature sensors, thermostats, and other devices for controlling the temperature, humidity, airflow, or other variable conditions within building 10. Lighting subsystem 442 can include any number of light fixtures, ballasts, lighting sensors, dimmers, and/or other devices configured to controllably adjust the amount of light provided to a building space. Security subsystem 438 can include occupancy sensors, video surveillance cameras, digital video recorders, video processing servers, intrusion detection devices, access control devices and servers, and/or other security-related devices.

Still referring to FIG. 4, BMS controller 366 is shown to include a communications interface 407 and a BMS interface 409. Communications interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Communications interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Communications interfaces 407 and/or BMS interface 409 can be or include wired or wireless communications interfaces (e.g., jacks, antennas, transmitters, receivers, transceivers, wire terminals, etc.) for conducting data communications with building subsystems 428 or other external systems or devices. In various embodiments, communications via communications interfaces 407 and/or BMS interface 409 can be direct (e.g., local wired or wireless communications) or via a communications network 446 (e.g., a WAN, the Internet, a cellular network, etc.). For example, communications interfaces 407 and/or BMS interface 409 can include an Ethernet card and port for sending and receiving data via an Ethernet-based communications link or network. In another example, communications interfaces 407 and/or BMS interface 409 can include a Wi-Fi transceiver for communicating via a wireless communications network. In another example, one or both of communications interfaces 407 and BMS interface 409 can include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 can be communicably connected to BMS interface 409 and/or communications interface 407 such that processing circuit 404 and the various components thereof can send and receive data via communications interfaces 407 and/or BMS interface 409. Processor 406 can be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 408 can be or include volatile memory or non-volatile memory. Memory 408 can include database components, object code components, script components, or any other type of information structure for supporting the various activities and information structures described in the present application. According to some embodiments, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments BMS controller 366 can be distributed across multiple servers or computers (e.g., that can exist in distributed locations). Further, while FIG. 4 shows applications 422 and 426 as existing outside of BMS controller 366, in some embodiments, applications 422 and 426 can be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 can be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 can be configured to serve clients or local applications with information and services to support a variety of enterprise-level applications. For example, enterprise control applications 426 can be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 can work with layers 410-420 to optimize building performance (e.g., efficiency, energy use, comfort, or safety) based on inputs received at communications interface 407 and/or BMS interface 409.

Building subsystem integration layer 420 can be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translate communications (e.g., sensor data, input signals, output signals, etc.) across a plurality of multi-vendor/multi-protocol systems.

Demand response layer 414 can be configured to optimize resource usage (e.g., electricity use, natural gas use, water use, etc.) and/or the monetary cost of such resource usage in response to satisfy the demand of building 10. The optimization can be based on time-of-use prices, curtailment signals, energy availability, or other data received from utility providers, distributed energy generation systems 424, from energy storage 427 (e.g., hot TES tank 242, cold TES tank 244, etc.), or from other sources. Demand response layer 414 may receive inputs from other layers of BMS controller 366 (e.g., building subsystem integration layer 420, integrated control layer 418, etc.). The inputs received from other layers can include environmental or sensor inputs (e.g., internal to building 10, external to building 10, etc.) such as temperature, carbon dioxide levels, relative humidity levels, air quality sensor outputs, occupancy sensor outputs, room schedules, weather conditions, and the like. The inputs may also include inputs such as electrical use (e.g., expressed in kWh), thermal load measurements, pricing information, projected pricing, smoothed pricing, curtailment signals from utilities, and the like.

According to some embodiments, demand response layer 414 includes control logic for responding to the data and signals it receives. These responses can include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints, etc.) which minimize energy costs based on one or more inputs representative of or based on demand (e.g., price, a curtailment signal, a demand level, etc.). In some embodiments, demand response layer 414 uses equipment models to determine an optimal set of control actions. The equipment models can include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions can be edited or adjusted by a user (e.g., via a graphical user interface, etc.) so that the control actions initiated in response to demand inputs can be tailored for the user's application, desired comfort level, particular building equipment, and/or based on other concerns. For example, the demand response policy definitions can specify which equipment can be turned on or off in response to particular demand inputs, how long a system or piece of equipment should be turned off, what setpoints can be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and/or when to dispatch on-site generation of energy (e.g., via fuel cells, a motor generator set, etc.).

Integrated control layer 418 can be configured to use the data input or output of building subsystem integration layer 420 and/or demand response later 414 to make control decisions. Due to the subsystem integration provided by building subsystem integration layer 420, integrated control layer 418 can integrate control activities of the subsystems 428 such that the subsystems 428 behave as a single integrated supersystem. In some embodiments, integrated control layer 418 includes control logic that uses inputs and outputs from a plurality of building subsystems to provide greater comfort and energy savings relative to the comfort and energy savings that separate subsystems could provide alone. For example, integrated control layer 418 can be configured to use an input from a first subsystem to make an energy-saving control decision for a second subsystem. Results of these decisions can be communicated back to building subsystem integration layer 420.

Integrated control layer 418 is shown to be logically below demand response layer 414. Integrated control layer 418 can be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 can be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 can be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and automated measurement and validation layer 412. Integrated control layer 418 can be configured to provide calculated inputs (e.g., aggregations) to these higher levels based on outputs from more than one building subsystem.

Automated measurement and validation (AM&V) layer 412 can be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 can be based on building system energy models and/or equipment models for individual BMS devices or subsystems. For example, AM&V layer 412 may compare a model-predicted output with an actual output from building subsystems 428 to determine an accuracy of the model.

Fault detection and diagnostics (FDD) layer 416 can be configured to provide on-going fault detection for building subsystems 428, building subsystem devices (i.e., building equipment), and control algorithms used by demand response layer 414 and integrated control layer 418. FDD layer 416 may receive data inputs from integrated control layer 418, directly from one or more building subsystems or devices, and/or from another data source. FDD layer 416 may automatically diagnose and respond to detected faults. The responses to detected or diagnosed faults can include providing an alert message to a user, a maintenance scheduling system, or a control algorithm configured to attempt to repair the fault or to work-around the fault.

FDD layer 416 can be configured to output a specific identification of the faulty component or cause of the fault (e.g., loose damper linkage, etc.) using detailed subsystem inputs available at building subsystem integration layer 420. In other exemplary embodiments, FDD layer 416 is configured to provide “fault” events to integrated control layer 418 which executes control strategies and policies in response to the received fault events. According to some embodiments, FDD layer 416 (or a policy executed by an integrated control engine or business rules engine) may shut-down systems or direct control activities around faulty devices or systems to reduce energy waste, extend equipment life, or assure proper control response.

FDD layer 416 can be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (i.e., time-series) data indicating the performance of BMS 400 and the various components thereof. The data generated by building subsystems 428 can include measured or calculated values that exhibit statistical characteristics and provide information about how the corresponding system or process (e.g., a temperature control process, a flow control process, etc.) is performing in terms of error from its setpoint. These processes can be examined by FDD layer 416 to expose when the system begins to degrade in performance and alert a user to repair the fault before it becomes more severe.

Several examples of FDD models and processes that can be used by the system 400 are described in detail in U.S. Pat. No. 10,969,775 granted Apr. 6, 2021, U.S. Pat. No. 10,700,942 granted Jun. 30, 2020, U.S. Pat. No. 9,568,910 granted Feb. 14, 2017, U.S. Pat. No. 10,281,363 granted May 7, 2019, U.S. Pat. No. 10,747,187 granted Aug. 18, 2020, U.S. Pat. No. 9,753,455 granted Sep. 5, 2017, and U.S. Pat. No. 8,731,724 granted May 20, 2014. The entire disclosures of each of these patents are incorporated by reference herein. The system 400 can use these or other FDD models or processes to help diagnose the root causes of problems associated with the building equipment and identify the particular actions that can be taken by the system 400 or by service providers (e.g., performing service on building equipment, repairing or replacing building equipment, switching to a new control strategy, automatically updating device software or firmware, etc.) to improve the performance of the building equipment and resolve the problems associated with the service requests and/or service reports for the building equipment.

In some embodiments, the system 400 may have associated warranty data. In some embodiments, the warranty data include reliability data that indicate the failure rates, expected time until failure, or other reliability metrics of various types of building equipment (e.g., particular equipment models) or components thereof. The reliability data can be generated from a set of service actions performed by a manufacturer or service provider and/or warranty claims submitted by various customers across a large set of building equipment over time. In some embodiments, the warranty data include freeform text included in warranty claims, photographs or videos of failed equipment, service reports generated when performing service on equipment under warranty, or any other type of data associated with equipment under warranty. These and other examples of warranty data are described in greater detail in U.S. patent application Ser. No. 17/971,342 filed Oct. 21, 2022, U.S. patent application Ser. No. 18/116,974 filed Mar. 3, 2023, U.S. patent application Ser. No. 17/530,257 filed Nov. 18, 2021, and Singapore patent Application No. 10202250321D filed Jun. 28, 2022, the entire disclosures of which are incorporated by reference herein. The warranty data can include structured and/or unstructured data of any type or format.

### Building Management System 500

Referring now to FIG. 5, a block diagram of another building management system (BMS) 500 is shown, according to some embodiments. BMS 500 can be used to monitor and control the devices of HVAC system 100, waterside system 200, airside system 300, building subsystems 428, as well as other types of BMS devices (e.g., lighting equipment, security equipment, etc.) and/or HVAC equipment. In some embodiments, the building management system includes a maintenance scheduling and optimization system.

BMS 500 provides a system architecture that facilitates automatic equipment discovery and equipment model distribution. Equipment discovery can occur on multiple levels of BMS 500 across multiple different communications busses (e.g., a system bus 554, zone buses 556-560 and 564, sensor/actuator bus 566, etc.) and across multiple different communications protocols. In some embodiments, equipment discovery is accomplished using active node tables, which provide status information for devices connected to each communications bus. For example, each communications bus can be monitored for new devices by monitoring the corresponding active node table for new nodes. When a new device is detected, BMS 500 can begin interacting with the new device (e.g., sending control signals, using data from the device) without user interaction.

Some devices in BMS 500 present themselves to the network using equipment models. An equipment model defines equipment object attributes, view definitions, schedules, trends, and the associated BACnet value objects (e.g., analog value, binary value, multistate value, etc.) that are used for integration with other systems. Some devices in BMS 500 store their own equipment models. Other devices in BMS 500 have equipment models stored externally (e.g., within other devices). For example, a zone coordinator 508 can store the equipment model for a bypass damper 528. In some embodiments, zone coordinator 508 automatically creates the equipment model for bypass damper 528 or other devices on zone bus 558. Other zone coordinators can also create equipment models for devices connected to their zone busses. The equipment model for a device can be created automatically based on the types of data points exposed by the device on the zone bus, device type, and/or other device attributes. Several examples of automatic equipment discovery and equipment model distribution are discussed in greater detail below.

Still referring to FIG. 5, BMS 500 is shown to include a maintenance scheduling and optimization system 502, a system manager 503; several zone coordinators 506, 508, 510 and 518; and several zone controllers 524, 530, 532, 536, 548, and 550. System manager 503 can monitor various data points in BMS 500 and report monitored variables to maintenance scheduling and optimization system 502. System manager 503 can communicate with client devices 504 (e.g., user devices, desktop computers, laptop computers, mobile devices, etc.) via a data communications link 574 (e.g., BACnet IP, Ethernet, wired or wireless communications, etc.). System manager 503 can provide a user interface to client devices 504 via data communications link 574. The user interface may allow users to monitor and/or control BMS 500 via client devices 504.

In some embodiments, system manager 503 is connected with zone coordinators 506-510 and 518 via a system bus 554. System manager 503 can be configured to communicate with zone coordinators 506-510 and 518 via system bus 554 using a master-slave token passing (MSTP) protocol or any other communications protocol. System bus 554 can also connect system manager 503 with other devices such as a constant volume (CV) rooftop unit (RTU) 512, an input/output module (IOM) 514, a thermostat controller 516 (e.g., a TEC5000 series thermostat controller), and a network automation engine (NAE) or third-party controller 520. RTU 512 can be configured to communicate directly with system manager 503 and can be connected directly to system bus 554. Other RTUs can communicate with system manager 503 via an intermediate device. For example, a wired input 562 can connect a third-party RTU 542 to thermostat controller 516, which connects to system bus 554.

System manager 503 can provide a user interface for any device containing an equipment model. Devices such as zone coordinators 506-510 and 518 and thermostat controller 516 can provide their equipment models to system manager 503 via system bus 554. In some embodiments, system manager 503 automatically creates equipment models for connected devices that do not contain an equipment model (e.g., IOM 514, third party controller 520, etc.). For example, system manager 503 can create an equipment model for any device that responds to a device tree request. The equipment models created by system manager 503 can be stored within system manager 503. System manager 503 can then provide a user interface for devices that do not contain their own equipment models using the equipment models created by system manager 503. In some embodiments, system manager 503 stores a view definition for each type of equipment connected via system bus 554 and uses the stored view definition to generate a user interface for the equipment.

Each zone coordinator 506-510 and 518 can be connected with one or more of zone controllers 524, 530-532, 536, and 548-550 via zone buses 556, 558, 560, and 564. Zone coordinators 506-510 and 518 can communicate with zone controllers 524, 530-532, 536, and 548-550 via zone busses 556-560 and 564 using a MSTP protocol or any other communications protocol. Zone busses 556-560 and 564 can also connect zone coordinators 506-510 and 518 with other types of devices such as variable air volume (VAV) RTUs 522 and 540, changeover bypass (COBP) RTUs 526 and 552, bypass dampers 528 and 546, and PEAK controllers 534 and 544.

Zone coordinators 506-510 and 518 can be configured to monitor and command various zoning systems. In some embodiments, each zone coordinator 506-510 and 518 monitors and commands a separate zoning system and is connected to the zoning system via a separate zone bus. For example, zone coordinator 506 can be connected to VAV RTU 522 and zone controller 524 via zone bus 556. Zone coordinator 508 can be connected to COBP RTU 526, bypass damper 528, COBP zone controller 530, and VAV zone controller 532 via zone bus 558. Zone coordinator 510 can be connected to PEAK controller 534 and VAV zone controller 536 via zone bus 560. Zone coordinator 518 can be connected to PEAK controller 544, bypass damper 546, COBP zone controller 548, and VAV zone controller 550 via zone bus 564.

A single model of zone coordinator 506-510 and 518 can be configured to handle multiple different types of zoning systems (e.g., a VAV zoning system, a COBP zoning system, etc.). Each zoning system can include a RTU, one or more zone controllers, and/or a bypass damper. For example, zone coordinators 506 and 510 are shown as Verasys VAV engines (VVEs) connected to VAV RTUs 522 and 540, respectively. Zone coordinator 506 is connected directly to VAV RTU 522 via zone bus 556, whereas zone coordinator 510 is connected to a third-party VAV RTU 540 via a wired input 568 provided to PEAK controller 534. Zone coordinators 508 and 518 are shown as Verasys COBP engines (VCEs) connected to COBP RTUs 526 and 552, respectively. Zone coordinator 508 is connected directly to COBP RTU 526 via zone bus 558, whereas zone coordinator 518 is connected to a third-party COBP RTU 552 via a wired input 570 provided to PEAK controller 544.

Zone controllers 524, 530-532, 536, and 548-550 can communicate with individual BMS devices (e.g., sensors, actuators, etc.) via sensor/actuator (SA) busses. For example, VAV zone controller 536 is shown connected to networked sensors 538 via SA bus 566. Zone controller 536 can communicate with networked sensors 538 using a MSTP protocol or any other communications protocol. Although only one SA bus 566 is shown in FIG. 5, it should be understood that each zone controller 524, 530-532, 536, and 548-550 can be connected to a different SA bus. Each SA bus can connect a zone controller with various sensors (e.g., temperature sensors, humidity sensors, pressure sensors, light sensors, occupancy sensors, etc.), actuators (e.g., damper actuators, valve actuators, etc.) and/or other types of controllable equipment (e.g., chillers, heaters, fans, pumps, etc.).

Each zone controller 524, 530-532, 536, and 548-550 can be configured to monitor and control a different building zone. Zone controllers 524, 530-532, 536, and 548-550 can use the inputs and outputs provided via their SA busses to monitor and control various building zones. For example, a zone controller 536 can use a temperature input received from networked sensors 538 via SA bus 566 (e.g., a measured temperature of a building zone) as feedback in a temperature control algorithm. Zone controllers 524, 530-532, 536, and 548-550 can use various types of control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control a variable state or condition (e.g., temperature, humidity, airflow, lighting, etc.) in or around building 10.

### Maintenance Scheduling and Optimization System for Connected Equipment

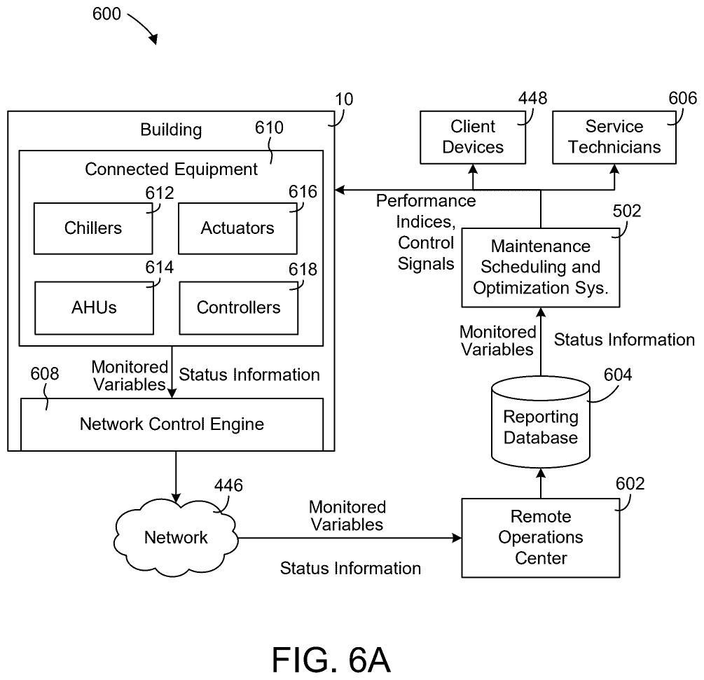

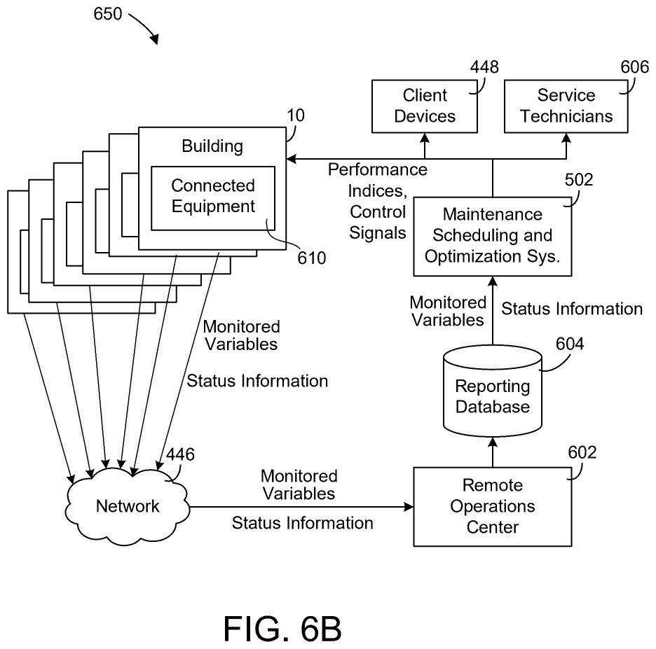

Referring now to FIG. 6A, a block diagram of another building management system (BMS) 600 which includes the maintenance scheduling and optimization system for determining an optimized servicing schedule is shown, according to some embodiments. BMS 600 can include many of the same components as BMS 400 and BMS 500 as described with reference to FIGS. 4 and 5. For example, BMS 600 is shown to include building 10, network 446, client devices 448, and maintenance scheduling and optimization system 502. Building 10 is shown to include connected equipment 610, which can include any type of equipment used to monitor and/or control building 10. Connected equipment 610 can include connected chillers 612, connected AHUs 614, connected actuators 616, connected controllers 618, or any other type of equipment in a building HVAC system (e.g., boilers, economizers, valves, dampers, cooling towers, fans, pumps, etc.) or building management system (e.g., lighting equipment, security equipment, refrigeration equipment, etc.). Connected equipment 610 can include any of the equipment of HVAC system 100, waterside system 200, airside system 300, BMS 400, and/or BMS 500, as described with reference to FIGS. 1-5.

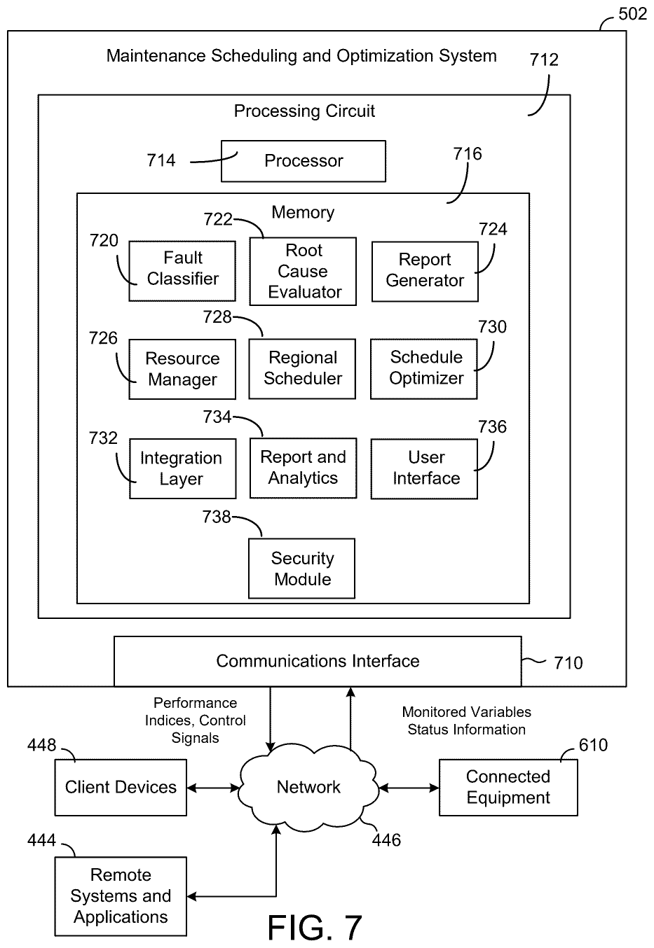

Connected equipment 610 can be outfitted with sensors to monitor particular conditions of the connected equipment 610. For example, chillers 612 can include sensors configured to monitor chiller variables such as chilled water return temperature, chilled water supply temperature, chilled water flow status (e.g., mass flow rate, volume flow rate, etc.), condensing water return temperature, condensing water supply temperature, motor amperage (e.g., of a compressor, etc.), variable speed drive (VSD) output frequency, and refrigerant properties (e.g., refrigerant pressure, refrigerant temperature, condenser pressure, evaporator pressure, etc.) at various locations in the refrigeration circuit. An example of a chiller 700 which can be used as one of chillers 612 is described in greater detail with reference to FIG. 7. Similarly, AHUs 614 can be outfitted with sensors to monitor AHU variables such as supply air temperature and humidity, outside air temperature and humidity, return air temperature and humidity, chilled fluid temperature, heated fluid temperature, damper position, etc. In general, connected equipment 610 monitor and report variables that characterize the performance of the connected equipment 610. Each monitored variable can be forwarded to network control engine 608 as a data point (e.g., including a point ID, a point value, etc.).

Monitored variables can include any measured or calculated values indicating the performance of connected equipment 610 and/or the components thereof. For example, monitored variables can include one or more measured or calculated temperatures (e.g., refrigerant temperatures, cold water supply temperatures, hot water supply temperatures, supply air temperatures, zone temperatures, etc.), pressures (e.g., evaporator pressure, condenser pressure, supply air pressure, etc.), flow rates (e.g., cold water flow rates, hot water flow rates, refrigerant flow rates, supply air flow rates, etc.), valve positions, resource consumptions (e.g., power consumption, water consumption, electricity consumption, etc.), control setpoints, model parameters (e.g., regression model coefficients, etc.), and/or any other time-series values that provide information about how the corresponding system, device, and/or process is performing. Monitored variables can be received from connected equipment 610 and/or from various components thereof. For example, monitored variables can be received from one or more controllers (e.g., BMS controllers, subsystem controllers, HVAC controllers, subplant controllers, AHU controllers, device controllers, etc.), BMS devices (e.g., chillers, cooling towers, pumps, heating elements, etc.), and/or collections of BMS devices.

Connected equipment 610 can also report equipment status information. Equipment status information can include, for example, the operational status of the equipment, an operating mode (e.g., low load, medium load, high load, etc.), an indication of whether the equipment is running under normal or abnormal conditions, a safety fault code, and/or any other information that indicates the current status of connected equipment 610. In some embodiments, equipment status information reported by the connected equipment 610 is in the form of status codes. For example, four types of status codes can be reported by a connected equipment (e.g., chiller), including safety shutdown codes (safety codes), warning codes, cycling codes, and operation codes. The status codes are described in greater detail herein below in this disclosure.

In some embodiments, each device of connected equipment 610 includes a control panel. The control panel can use the sensor data to shut down the device if the control panel determines that the device is operating under unsafe conditions. For example, the control panel can compare the sensor data (or a value derived from the sensor data) to predetermined thresholds. If the sensor data or calculated value crosses a safety threshold, the control panel can shut down the device and/or operate the device at a derated setpoint. The control panel can generate a data point when a safety shut down or a derate occurs. The data point can include a safety fault code which indicates the reason or condition that triggered the shut down or derate.

Connected equipment 610 can provide monitored variables and equipment status information to a network control engine 608. Network control engine 608 can include a building controller (e.g., BMS controller 366), a system manager (e.g., system manager 503), a network automation engine (e.g., NAE 520), or any other system or device of building 10 configured to communicate with connected equipment 610. In some embodiments, the monitored variables and the equipment status information are provided to network control engine 608 as data points. Each data point can include a point ID and/or a point value. The point ID can identify the type of data point and/or a variable measured by the data point (e.g., condenser pressure, refrigerant temperature, fault code, etc.). Monitored variables can be identified by name or by an alphanumeric code (e.g., Chilled_Water_Temp, 7694, etc.). The point value can include an alphanumeric value indicating the current value of the data point (e.g., 44° F., fault code 4, etc.).

Network control engine 608 can broadcast the monitored variables and the equipment status information to a remote operations center (ROC) 602. ROC 602 can provide remote monitoring services and can send an alert to building 10 in the event of a critical alarm. ROC 602 can push the monitored variables and equipment status information to a reporting database 604, where the data is stored for reporting and analysis. Maintenance scheduling and optimization system 502 can access database 604 to retrieve the monitored variables and the equipment status information.

In some embodiments, maintenance scheduling and optimization system 502 is a component of BMS controller 366 (e.g., within FDD layer 416). For example, maintenance scheduling and optimization system 502 can be implemented as part of a METASYS® brand building automation system, as sold by Johnson Controls Inc. In other embodiments, maintenance scheduling and optimization system 502 can be a component of a remote computing system or cloud-based computing system configured to receive and process data from one or more building management systems. For example, maintenance scheduling and optimization system 502 can connect the connected equipment 610 (e.g., chillers 612) to the cloud and collect real-time data for over a number of points (e.g., 50 points) on those equipment. In other embodiments, maintenance scheduling and optimization system 502 can be a component of a subsystem level controller (e.g., a HVAC controller, etc.), a subplant controller, a device controller (e.g., AHU controller 330, a chiller controller, etc.), a field controller, a computer workstation, a client device, and/or any other system and/or device that receives and processes monitored variables from connected equipment 610.

Maintenance scheduling and optimization system 502 may use the monitored variables to identify a current operating state of connected equipment 610. The current operating state can be examined by maintenance scheduling and optimization system 502 to expose when connected equipment 610 begins to degrade in performance and/or to predict when faults will occur. In some embodiments, maintenance scheduling and optimization system 502 determines whether the current operating state is a normal operating state or a faulty operating state. Maintenance scheduling and optimization system 502 may report the current operating state and/or the predicted faults to client devices 448, service technicians 606, building 10, and/or any other system and/or device. Communications between maintenance scheduling and optimization system 502 and other systems and/or devices can be direct and/or via an intermediate communications network, such as network 446. If the current operating state is identified as a faulty state or moving toward a faulty state, maintenance scheduling and optimization system 502 may generate an alert or notification for service technicians 606 to repair the fault or potential fault before it becomes more severe. In some embodiments, maintenance scheduling and optimization system 502 uses the current operating state to determine an appropriate control action for connected equipment 610.

In some embodiments, maintenance scheduling and optimization system 502 provides a web interface which can be accessed by service technicians 606, client devices 448, and other systems or devices. The web interface can be used to access the raw data in reporting database 604, view the results produced by the maintenance scheduling and optimization system, identify equipment in need of preventative maintenance, and otherwise interact with maintenance scheduling and optimization system 502. Service technicians 606 can access the web interface to view a list of equipment for which faults are predicted by maintenance scheduling and optimization system 502. Service technicians 606 can use the predicted faults to proactively repair connected equipment 610 before a fault and/or an unexpected shut down occurs. These and other features of maintenance scheduling and optimization system 502 are described in greater detail below.

Referring now to FIG. 6B, a block diagram of another building management system (BMS) 650 is shown, according to some embodiments. The building management system 650 of FIG. 6B includes the components of the building management system 600 of FIG. 6A, plus any number of additional buildings 10 with additional groups of connected equipment 610. The multiple buildings 10 and multiple units of connected 610 can be considered as a fleet of buildings and/or equipment. The buildings 10 and connected equipment 610 can be located in one location (e.g., one campus) or multiple locations, including across geographic regions, states, provinces, territories, countries, continents, etc. FIG. 6B illustrates that the network 446 can connect all such buildings 10 and connected equipment 610 to the remote operations center 602 (e.g., via the Internet). Data from the multiple sets of connected equipment 610 that serve different buildings 10 can be aggregated, tagged, filtered, displayed on dashboards, etc. in order to provide a wide variety of fleet analytics and insights into operation of the building management system 650 and the connected equipment 610.

Referring now to FIG. 7, a block diagram illustrating the maintenance scheduling and optimization system 502 in greater detail is shown, according to some embodiments. Maintenance scheduling and optimization system 502 is shown to include a communications interface 710 and a processing circuit 712. Communications interface 710 may facilitate communications between maintenance scheduling and optimization system 502 and various external systems or devices. For example, maintenance scheduling and optimization system 502 may receive the monitored variables from connected equipment 610 and provide control signals, performance indices, and/or other information of detected faults to connected equipment 610 via communications interface 710. Communications interface 710 may also be used to communicate with remote systems and applications 444, client devices 448, and/or any other external system or device. For example, maintenance scheduling and optimization system 502 may provide performance indices and other information of detected faults to remote systems and applications 444, client devices 448, service technicians 606, or any other external system or device via communications interface 710.

Communications interface 710 can include any number and/or type of wired or wireless communications interfaces (e.g., jacks, antennas, transmitters, receivers, transceivers, wire terminals, etc.). For example, communications interface 710 can include an Ethernet card and port for sending and receiving data via an Ethernet-based communications link or network. As another example, communications interface 710 can include a Wi-Fi transceiver, a NFC transceiver, a cellular transceiver, a mobile phone transceiver, or the like for communicating via a wireless communications network. In some embodiments, communications interface 710 includes RS232 and/or RS485 circuitry for communicating with BMS devices (e.g., chillers, controllers, etc.). Communications interface 710 can be configured to use any of a variety of communications protocols (e.g., BACnet, Modbus, N2, MSTP, Zigbee, etc.). Communications via interface 710 can be direct (e.g., local wired or wireless communications) or via an intermediate communications network 446 (e.g., a WAN, the Internet, a cellular network, etc.). Communications interface 710 can be communicably connected with processing circuit 712, and the various components thereof can send and receive data via communications interface 710.

Processing circuit 712 is shown to include a processor 714 and memory 716. Processor 714 can be implemented as a general purpose processor, an application specific integrated circuit (ASIC), one or more field programmable gate arrays (FPGAs), a group of processing components, or other suitable electronic processing components. Memory 716 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 716 can be or include volatile memory or non-volatile memory. Memory 716 can include database components, object code components, script components, or any other type of information structure for supporting the various activities and information structures described in the present application. According to some embodiments, memory 716 is communicably connected to processor 714 via processing circuit 712 and includes computer code for executing (e.g., by processing circuit 712 and/or processor 714) one or more processes described herein.

Still referring to FIG. 7, in some embodiments, the memory 716 can include at least a fault classifier 720, a root cause evaluator 722, a report generator 724, a resource manager 726, a regional scheduler 728, a schedule optimizer 730, an integration layer 732, a report and analytics module 734, a user interface 736, and a security and authentication module 738. In other embodiments, more, less, or different modules or components can be stored in memory 716. In some embodiments, the modules 720-738 can be implemented in one apparatus. In other embodiments, each of the modules 720-738 can be implemented in different and separate apparatuses and/or executed by different and separate processors, or a combination thereof. In some embodiments, modules 720-738 stored in a non-transitory computer readable medium (e.g., memory 716) can be executed by the processor 714 to perform operations as described herein. In some embodiments, each of the modules 720-738 or a combination of some of the modules 720-738 can be implemented as hardware circuits.

The fault classifier 720 may classify faults experienced by, for example, building equipment. The fault classifier 720 may classify a fault as either an issue requiring an on-site service visit (e.g., a service technician must be dispatched to the location of the equipment experiencing the fault) or an issue able to be resolved or fixed remotely. For example, a fault requiring an on-site service visit may be related to a broken physical component of the equipment that has to be replaced. A fault able to be resolved remotely may be, for example, a software update of the equipment. The fault classifier 720 may transmit information about whether a fault requires a remote or on-site fix to the schedule optimizer 730 for use in generating a schedule.

In some embodiments, fault classifier 720 receives operating data in real-time, or in near real-time (e.g., instantaneously, within a few seconds, within a few minutes, etc.). Accordingly, the faults may be determined and categorized continuously or at regular intervals. For example, fault classifier 720 may categorize all the faults detected in a building within a 24 hour period at the end of the 24 hour period. As another example, fault classifier 720 may categorize the faults as they are detected in real time. Accordingly, the fault categorizations can be compared over time, to update machine learning models used to categorize the faults.

In some embodiments, fault classifier 720 may analyze the operating data according to a plurality of rules and categorize the faults based the plurality of rules. Several examples of rule-based fault detection systems and processes that can be used by the fault classifier to analyze the operating data and detect faults are described in detail in U.S. Pat. No. 10,969,775 granted Apr. 6, 2021, U.S. Pat. No. 10,700,942 granted Jun. 30, 2020, U.S. Pat. No. 9,568,910 granted Feb. 14, 2017, U.S. Pat. No. 10,281,363 granted May 7, 2019, U.S. U.S. Pat. No. 10,747,187 granted Aug. 18, 2020, U.S. Pat. No. 9,753,455 granted Sep. 5, 2017, and U.S. Pat. No. 8,731,724 granted May 20, 2014. The entire disclosures of each of these patents are incorporated by reference herein.

In some embodiments, the plurality of rules may make up a fault categorization model which may be stored in the fault classifier 720. The fault categorization model may be configured to receive the operating data of the building and detected faults as inputs to the model. The fault categorization model may then analyze the operating data and the detected faults based on the plurality of rules which make the fault categorization model and then outputs a categorization for each fault based on the fault categorization model. In some embodiments, the fault categorization model may be a machine learning model and/or artificial intelligence model (e.g., a neural network, a random forest, a support vector machine, etc.). The fault categorization model may be trained to better categorize faults based on the operating data received and previously categorization of faults. In some embodiments, the fault categorization model may be trained based on user feedback received from a user (e.g., building technicians, building administrators, building managers, etc.). For example, the fault categorization model may receive an AHU fault and operating data related to an AHU fault and may initially categorize the fault as a “remote fix” fault. The technician may attempt to repair the fault remotely and realize that the fault is not repairable remotely. The technician may then provide this feedback to fault classifier 720. The feedback received from the technician may be used to train the fault categorization model so that model may correctly categorize the AHU fault as an “on-site fix” fault thus making the model more accurate.

The root cause evaluator 722 may determine a root cause of a fault classified by the fault classifier 720. For example, the root cause evaluator 722 may determine whether or not the root cause of the fault is the equipment. If the root cause is the equipment, the equipment may be serviced by the service technician. If the root cause is not the equipment, the equipment may be required to be serviced by a third-party service technician.

In some embodiments, the maintenance scheduling and optimization system 502 may include fault detection and diagnostic (FDD) models or processes that can be used by the maintenance scheduling and optimization system 502 to detect faults or problems associated with the building equipment, predict the root causes of the faults or problems, and/or determine actions that are predicted to resolve the root causes of the faults or problems. In some embodiments, the FDD models or processes require additional information or data not included in the service requests or service reports. The maintenance scheduling and optimization system 502 can automatically gather the additional information or data needed by the FDD models or processes and provide the additional information as inputs to support the FDD activities. Several examples of FDD models and processes that can be used by the maintenance scheduling and optimization system 502 are described in detail in U.S. Pat. No. 10,969,775 granted Apr. 6, 2021, U.S. Pat. No. 10,700,942 granted Jun. 30, 2020, U.S. Pat. No. 9,568,910 granted Feb. 14, 2017, U.S. Pat. No. 10,281,363 granted May 7, 2019, U.S. Pat. No. 10,747,187 granted Aug. 18, 2020, U.S. Pat. No. 9,753,455 granted Sep. 5, 2017, and U.S. Pat. No. 8,731,724 granted May 20, 2014. The entire disclosures of each of these patents are incorporated by reference herein. The maintenance scheduling and optimization system 502 can use these or other FDD models or processes to help diagnose the root causes of problems associated with the building equipment and identify the particular actions that can be taken by the maintenance scheduling and optimization system 502 or by service providers (e.g., performing service on building equipment, repairing or replacing building equipment, switching to a new control strategy, automatically updating device software or firmware, etc.) to improve the performance of the building equipment and resolve the problems associated with the service requests and/or service reports for the building equipment.

In some embodiments, the maintenance scheduling and optimization system 502 may include a data source in the form of one or more digital twins, ontological models, relational models, graph data structures, causal relationship models, and/or other types of models that define relationships between various entities in a building system. For example, the data sources may include a digital twin or graph data structure of the building system which includes a plurality of nodes and a plurality of edges. The plurality of nodes may represent various entities in the building system such as systems or devices of building equipment (e.g., chillers, AHUs, security equipment, temperature sensors, a chiller subplant, an airside system, dampers, ducts, etc.), spaces of the building system (e.g., rooms, floors, building zones, parking lots, outdoor areas, etc.), persons in the building system or associated with the building system (e.g., building occupants, building employees, security or maintenance personnel, service providers for building equipment, etc.), data storage devices, computing devices, data generated by various entities, or any other entity that can be defined in the building system. The plurality of edges may connect the plurality of nodes and define relationships between the entities represented by the plurality of nodes. For example, a first entity in the graph data structure may be a node representing a particular building space (e.g., “zone A”) whereas a second entity in the graph data structure may be a node representing an air handling unit (e.g., “AHU B”) that serves the building space. The nodes representing the first and second entities may be connected by an edge indicating a relationship between the entities. For example, the zone A entity may be connected to the “AHU B” entity via a “served by” relationship indicating that zone A is served by AHU B.

Several examples of digital twins, ontological models, relational models, graph data structures, causal relationship models, and/or other types of models that define relationships between various entities in a building system are described in detail in U.S. Pat. No. 11,108,587 granted Aug. 31, 2021, U.S. Pat. No. 11,164,159 granted Nov. 2, 2021, U.S. Pat. No. 11,275,348 granted Mar. 15, 2022, U.S. patent application Ser. No. 16/673,738 filed Nov. 4, 2019, U.S. patent application Ser. No. 16/685,834 filed Nov. 15, 2019, U.S. patent application Ser. No. 17/728,047 filed Apr. 25, 2022, U.S. patent application Ser. No. 17/134,661 filed Dec. 28, 2020, and U.S. patent application Ser. No. 17/170,533 filed Feb. 8, 2021. The entire disclosures of each of these patents and patent applications are incorporated by reference herein. The maintenance scheduling and optimization system 502 can use these and other types of relational models to determine which equipment have an impact on other equipment or particular building spaces, perform diagnostics to identify potential root causes of problems (e.g., by identifying upstream equipment which could be contributing to the problem or causing the problem), predict the impact of changes to a given item of building equipment on the other equipment or spaces served by the given item of equipment (e.g., by identifying downstream equipment or spaces impacted by a given item of building equipment), or otherwise derive insights that can be used by the maintenance scheduling and optimization system 502 to recommend various actions to perform (e.g., equipment service recommendations, diagnostic processes to run, etc.) and/or predict the consequences of various courses of action on the related equipment and spaces.

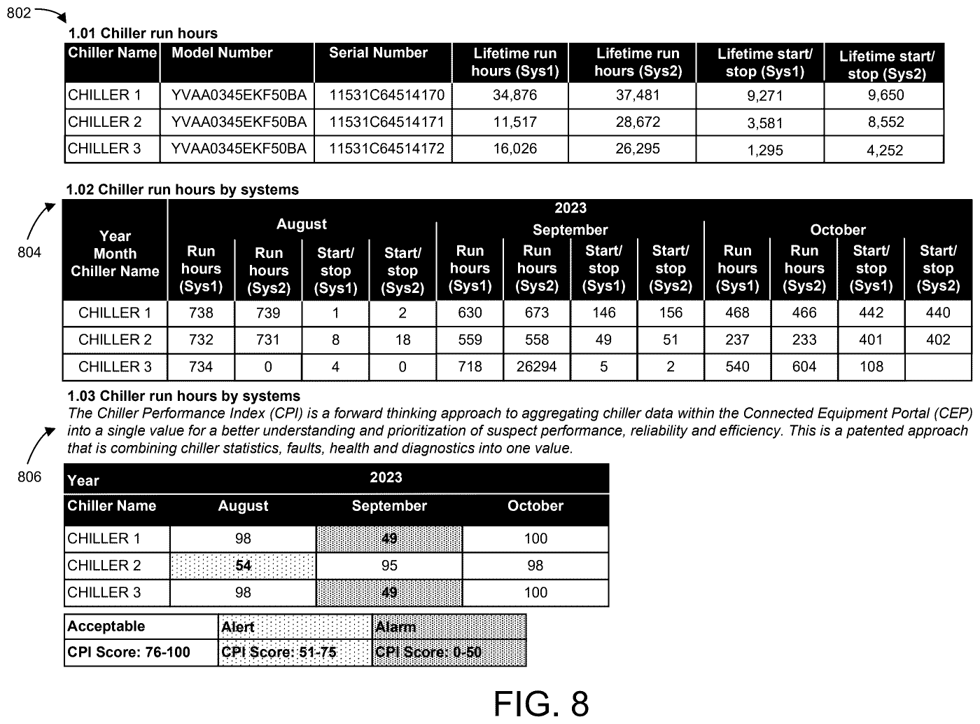

The report generator 724 may gather or receive historical data from the equipment or building site. The report generator 724 may also generate a report for a technician to prepare the service technician prior to making an on-site visit. Elements of an exemplary report generated by the report generator 724 are described with respect to FIGS. 8-14. For example, a report generated by the report generator 724 may include one or more data points relating to a run time of a piece of equipment (e.g., lifetime run hours), a performance index, a description of fault(s) experienced by the equipment, a number of occurrences of a fault, recommended actions to take to resolve the fault, etc. The report may also include performance metrics for a piece of equipment. The report may also include historical data relating to the equipment, such as previous service events. For example, if the technician is performing an on-site service event for a fault that was previously designated as a remote service event (e.g., a remote service technician could not remotely fix the fault and an on-site technician was reassigned the event), the report may include information on events the remote technician took to attempt to resolve the issue. The report may also include data indicating that a fault may occur in the future, based on historical data. For example, equipment may be experiencing an issue that has not yet caused a fault to be generated. The maintenance scheduling and optimization system 502 may be able to predict a fault that will or may occur based on historical data and the current issue.

The predicted future fault shown to the technician in the report may allow the technician to service the equipment to resolve the issue, in addition to servicing the equipment for an issue already causing a fault. This may reduce a downtime of the equipment and/or reduce time and costs associated with a technician servicing the same piece of equipment on multiple visits. Further, allowing a technician to service a piece of building equipment to address multiple issues (e.g., multiple existing faults and/or predicted faults at the same time) may cause improved equipment operation, fewer equipment failures, less equipment downtime, and more efficient equipment operation as a result of performing service on equipment quickly and efficiently.

In various embodiments, a technician assigned to service a fault may not possess expertise needed to service the equipment. Therefore, the report generated by the report generator 724 may guide the technician prior to the technician performing the service. The technician may understand what the problem is, which may reduce a servicing time. For example, if a technician receives a report indicating the fault of the equipment and what specific component needs to be serviced, the technician may begin servicing the component upon arriving at the site, whereas without the report the technician may need to take time to diagnose the issue and determine what component needs to be serviced. Thus, the service time may be reduced from, for example, 8 hours if the technician has not received a report, to 4 hours if the technician has received a report.

The report generator 724 may generate and send a report at certain intervals. For example, the report generator 724 may receive an indication of a report submission date that is indicative of when a service report should be sent out, such as to a service technician. For example, the report generator 724 may receive information indicating a reporting period for the report. For example, the information may indicate that the report includes data from the first day of the previous month to a last day of the previous month. The report generator 724 may also include information regarding a report submission date. For example, a report may be submitted and/or sent to a branch, a user, etc. on a certain day of the month (e.g., a report for the previous month should be submitted on the second day of the current month month). In some implementations, the report submission date may depend on a schedule of the service technician. For example, a technician may only be dispatched to an equipment site during a first or second week of the month, after the 15th of the month, etc. The report generator 724 may generate and send the report according to a service technician's schedule such that the technician receives the report prior to servicing the equipment/dispatching to the site.

The resource manager 726, also called the resource management system 726, may track, obtain, or determine an availability of resources across different branches and regions. Resources may include, for example, a technician, expertise of technicians, availability of technicians, tools, parts or components, vehicles, etc. Technicians may be remote technicians (e.g., located in remote operations centers) or on-site technicians (e.g., able to travel to a site). The resource manager 726 may provide real-time or substantially real-time information on resource utilization and may help to identify potential bottlenecks or shortages in capacity. The resource manager 726 may also help to forecast future workforce requirements to help organizational preparedness to meet the demand. By providing branches with information on resource requirements for each service visit or block of scheduled service visits, branch-level resource planning and coordination may be improved. This may cause or assist branch managers to, for example, allocate resources more effectively, anticipate staffing needs, and proactively address capacity constraints or shortages. In various embodiments, the resource manager 726 may determine one or more technician attributes. A technician attribute may be used to define one or more capabilities of a service technician. Technician attributes may be, for example, a proximity/distance from a building or building owner, consumer rating or reputation score, a number of years in service, credit score, average time to completion, a number of outstanding claims, annual revenue, average growth rate, average labor rate, liability, insurance, ethnic background, whether the technician has previously worked with the building owner, and/or other attributes that can be used to describe or characterize service technicians.

Resources determined by the resource manager 726 may be used by the maintenance scheduling and optimization system 502 to determine, when generating a maintenance schedule, a specific service technician to assign to a specific site or service event. For example, the resource manager 726 may indicate that a first technician possess more knowledge about a certain fault relative to a second technician. The maintenance scheduling and optimization system 502 may then generate a schedule that assigns the first technician to the fault instead of the second technician.

In various embodiments, the equipment site having the equipment to be serviced may include an on-site virtual agent (e.g., a generative artificial intelligence (GAI) model, a software agent, a virtual assistant, etc.). The virtual agent may communicate with a remote service technician to gather data required for FDD and/or to provide service by, for example trying various corrective actions and observing the response from the equipment. Responsive to detecting or predicting a fault, the virtual agent may be executed at the equipment site. The virtual agent may gather additional data for use, by the remote service agent, in diagnosing a cause of the fault or repairing the fault. For example, the virtual agent may operate cameras surrounding the equipment and transmit video footage to the remote technician, so the remote technician can view real-time footage of the equipment they are servicing. In some embodiments, the virtual agent may be implemented as a remote virtual agent and may be executed remote from the site (e.g., in service scenarios where a fault can be serviced remotely). Additional description of a GAI or virtual agent is provided in U.S. Provisional Patent Application No. 63/470,123, filed May 31, 2023, U.S. patent application Ser. No. 16/989,460, filed Aug. 10, 2020, U.S. patent application Ser. No. 17/700,188 filed Mar. 21, 2022, U.S. patent application Ser. No. 18/375,873 filed Oct. 2, 2023, U.S. patent application Ser. No. 18/375,871 filed Oct. 2, 2023, and U.S. patent application Ser. No. 17/737,847 filed May 5, 2022. The entire disclosures of each of these patent applications are incorporated by reference herein. In some embodiments, the remote service technician can also be replaced with a virtual agent, referred to as a remote virtual agent, such that both the on-site technician and the remote technician are implemented as virtual agents. In some embodiments, the remote service technician may be a human person, whereas the on-site service technician is an on-site virtual agent. In other embodiments, the remote service technician may be a remote virtual agent, whereas the on-site service technician may be a human person.

The on-site virtual agent may communicate with the remote technician or remote virtual agent to gather additional data for use in diagnosing a cause of a fault or repairing the fault. In some embodiments, the on-site virtual agent is able to perform on-site operations that are not capable of being performed remotely, such as exercising equipment, opening or closing doors, accessing closed-circuit security systems, or other on-site operations that are firewalled or locked from remote access (e.g., due to security or other restrictions). The remote virtual agent or service technician can request additional data from the on-site virtual agent, which may conduct on-site operations to supply the additional data to the remote virtual agent or service technician for use in FDD processes or repairs.

The regional scheduler 728, also referred to as regional scheduling model 728, generates an initial schedule for virtual inspection reports across different global regions. Regions include, for example, BSNA (Americas), EMEALA (Europe, Middle East, Africa), and APAC (Asia-Pacific). The regional scheduler 728 may obtain one or more constraints relating to when a service can be performed at a customer site. The constraints may be or be based on, for example, operating hours of a site or other customer data associated with the building, customer, and/or region. The regional scheduler 728 may utilize one or more inputs when generating the schedule. Inputs or parameters may include, for example, a frequency of maintenance visits, historical data on chiller unit performance, distance between inspection sites, and resource constraints. The regional scheduler 728 may also utilize, as inputs, unique characteristics and requirements of different global regions, such as BSNA, EMEALA, and APAC. This may enable the system to generate tailored scheduling strategies that optimize resource utilization and address region-specific challenges, thus resulting in improved overall efficiency and effectiveness.

For example, the regional scheduler 728 may receive information on a plurality of considerations to be taken into account when scheduling a service. The considerations may be region-specific, building-specific, industry-specific. For example, the regional scheduler 728 may receive information indicating that a national holiday occurs at a certain time in an APAC country. The regional scheduler 728 can communicate that information to the schedule optimizer 730 so that a service is not scheduled during the national holiday. The regional scheduler 728 may also receive information indicating that a certain business or building should or should not have maintenance scheduled during working hours. For example, a hospital may prefer that maintenance occurs during working hours so an issue can be resolved as quickly as possible with minimal interference to a surgery schedule. However, a different industry or building, such as a financial firm, may prefer that equipment is serviced during non-working hours or off-peak working hours.

The schedule optimizer 730 may perform an optimization to determine an optimal service schedule based on one or more inputs. Inputs may be, for example, service provider resources described with respect to the resource manager 726. Input parameters may also include, for example, an urgency of maintenance tasks. The schedule optimizer 730 may maximize and/or minimize one or more parameters when determining an optimal schedule. For example, the schedule optimizer 730 may optimize the schedule to maximize the coverage of units or location sites while minimizing the number of resources required for inspection. In some embodiments, preventive maintenance scheduling may rely solely on onsite technician visits. Thus, in various embodiments, the system may integrate virtual inspection reports into the scheduling process. For example, the schedule optimizer 730 may utilize the schedule as an input to an algorithm to optimally include virtual inspection reports. By leveraging remote monitoring technology and data analytics, the integration may allow for proactive identification of maintenance needs and more efficient allocation of resources. The schedule optimizer 730 may utilize one or more dynamic resource constraint optimization algorithms. The optimizations may adaptively adjust schedules based on real-time factors, such as technician availability, travel time, and site priorities. The optimization may provide optimal resource allocation and minimize downtime.

In various embodiments, an optimization process may determine a schedule for each service technician. The schedule may be, for example, a set of service events that the technician is to perform at specific times and locations. The optimization process may also allocate other resources required to perform the service (e.g., equipment parts, etc.). The schedule optimizer 730 may optimally schedule service(s) for various faults indicated by FDD components of the maintenance scheduling and optimization system 502. The scheduled services may be subject to, for example, constraints on technician availability, other service providers, and travel time. For example, the schedule optimizer 730 may receive information from the any of the components 720-728 (regional scheduler 728, resource manager 726, etc.) for use in generating an optimized schedule.

For example, the schedule optimizer 730 may perform an optimization process which aims to minimize an objective function. The objective function may quantify a level of service and an efficiency of a service schedule from a perspective of the service provider. For example, the objective function may be a summation of the various service activities that are to be performed. Each service activity may be assigned a value based on a criticality that the activity is performed and/or an elapsed amount of time between the time the fault is detected (e.g., by the FDD components) and the time the service is performed. Decision variables of the optimization process may be or include, for example, the set of service events to be performed. Each service event may be defined by a specific time, a specific location, and/or specific resources (e.g., technicians, parts, vehicles, etc.) used during the service event. Constraints in the optimization process may include an availability of service provider resources, travel time or down time for each service technician between service events, working hours for the customer, etc.

In some embodiments, the system 500 may include a predictive cost model that can be used by system 500 to predict operating cost, maintenance cost, equipment purchase or replacement cost (e.g., capital cost), equipment degradation cost, cost of purchasing carbon offset credits, rate of return (e.g., on an investment in energy-efficient equipment), payback period, and/or any of the other sources of monetary cost or cost-related metrics described in U.S. patent application Ser. No. 15/895,836 filed Feb. 13, 2018, U.S. patent application Ser. No. 16/418,686 filed May 21, 2019, U.S. patent application Ser. No. 16/438,961 filed Jun. 12, 2019, U.S. patent application Ser. No. 16/449,198 filed Jun. 21, 2019, U.S. patent application Ser. No. 16/457,314 filed Jun. 28, 2019, U.S. patent application Ser. No. 16/697,099 filed Nov. 26, 2019, U.S. patent application Ser. No. 16/687,571 filed Nov. 18, 2019, U.S. patent application Ser. No. 16/518,548 filed Jul. 22, 2019, U.S. patent application Ser. No. 16/899,220 filed Jun. 11, 2020, U.S. patent application Ser. No. 16/943,781 filed Jul. 30, 2020, and/or U.S. patent application Ser. No. 17/017,028 filed Sep. 10, 2020. The entire disclosures of each of these patent applications are incorporated by reference herein. The system 500 can use the predictive cost models to predict the cost that will result from various actions that could be performed by the system 500 or by service providers (e.g., purchasing and installing new equipment, performing maintenance on the building equipment, energy waste resulting from allowing a fault to remain unrepaired, switching to a new control strategy, etc.) to provide insight into the consequences of various courses of action that can be recommended by the system 500.

In various embodiments, the service schedule generated by the schedule optimizer 730 may include one or more service events. The service events may be based on the faults determined by the maintenance scheduling and optimization system 502, the classification of the faults as remote or on-site faults, the resources determined by the resource manager 726, etc. In various embodiments the generated service schedule may include both remote service events and on-site service events. The remote service events may be assigned to a remote service provider. The on-site service events may be assigned to an on-site service provider.

In some embodiments, the service schedule may include one or more remote service events assigned to a remote service technician. The remote service technician, upon an attempt to resolve the issue, maybe unable to successfully resolve the issue. The remote service technician may then provide an indication to one or more components of the maintenance scheduling and optimization system 502 for use by the schedule optimizer 730. The schedule optimizer may update the generated service schedule to replace the remote service event with an on-site service event. The replacement on-site service event may be scheduled such that there is minimal disruption or rearrangement of the previously generated service schedule. The schedule optimizer 730 may transmit an updated schedule to any technician that is affected by the schedule change. The technician(s) may receive a notification on a user device indicating that their schedule has been updated. In various embodiments, responsive to a technician being assigned the replacement on-site service event, the technician may receive a report, generated by the report generator 724. The report may include any relevant information for servicing the equipment. For example, the report may include previous service history events including the remote service event for the equipment.

In some embodiments, the schedule optimizer 730 may receive a first set of information relating to a piece of equipment. The first set of data may include, for example, a first set of operating data for the equipment and a first set of provider resources based on the first set of operating data. Operating data may be, for example, any data that characterizes the operation or performance of the equipment. For example, operating data may be sensor data, time-series of control signals, operating states, and/or power consumption. The schedule optimizer 730 may generate a service schedule based on the first set of information of the equipment. After generating the service schedule, but prior to the service event taking place, the schedule optimizer 730 may receive a second set of operating data for the equipment. The second set of operating data may indicate different service requirements for the equipment than what was indicated by the first set of operating data. For example, the second set of operating data may indicate that the root cause of the fault is different than indicated by the first set of operating data (e.g., when both sets of operating data are evaluated using FDD models as discussed above) such that different service provider resources are required to address the fault (e.g., technicians having different expertise, different tools, more time required, etc.). The schedule optimizer 730 may then utilize the second set of operating data to update the service schedule to replace the first service event with a second service event. The second service event may utilize a second set of provider resources to service the equipment.

In some embodiments, the schedule optimizer 730 may receive information relating to a first piece of equipment to be serviced (e.g., operational data). The schedule optimizer 730 may generate a schedule including a first service event to service the first piece of equipment. The first service event may include a first set of service provider resources (e.g., service technician, tools, time, etc.) used to perform service on the first piece of equipment at a specific time and location. The schedule optimizer 730 may, subsequent scheduling the first service event but prior to the first service event occurring, receive information relating to a second piece of equipment (e.g., operational data. The information relating to the second piece of equipment may indicate that the service needs of the second piece of equipment are of a higher priority than the service needs of the first piece of equipment. For example, the second piece of equipment may be more critical than the first piece of equipment, may provide a higher value to the customer than the first piece of equipment, may result in more energy consumption or cost when operating in the faulty condition than the first piece of equipment, or may otherwise be more important to fix quickly than the first piece of equipment. In some embodiments, the faults and service needs associated with various pieces of equipment are prioritized using the techniques described in U.S. Pat. No. 10,402,767 granted Sep. 3, 2019, the entire disclosure of which is incorporated by reference herein. The schedule optimizer 730 may then update the generated service schedule to replace the first service event to service the first piece of equipment with a second service event to service the second piece of equipment. In various embodiments, the service schedule may be updated if, for example, the time, technician, resources, etc. of the first service event interfere with the time, technician, resources, etc. needed to perform the second service event.

In various embodiments, after generating a service schedule, the schedule optimizer 730 may initiate an automated action to perform a service on the equipment. Initiating an automated action may include, for example, distributing the service schedule to one or more technicians assigned to service events in the service schedule. In various embodiments, a technician may receive a portion of the service schedule (e.g., a portion of the schedule only containing service events that the technician is assigned to). The schedule optimizer 730 may distribute the service schedule to, for example a user device associated with each technician. In some embodiments, the schedule optimizer 730 may distribute the service schedule for display on a dashboard of a user device.

The integration layer 732 may facilitate communication and data exchange between different modules and external systems. The integration layer 732 may facilitate, for example, the integration of virtual inspection reports, technician schedules, site awareness and resource constraints into the scheduling process.

The reporting and analytics module 734 generates reports on scheduled maintenance activities, resource utilization, and performance metrics. The reporting and analytics module 734 may provide insights into the effectiveness of the scheduling process and may help to identify areas for improvement. Advanced analytics and reporting capabilities may be used to emphasize data-driven decision making. By generating comprehensive reports on, for example, maintenance activities, resource utilization, and performance metrics, stakeholders may be able to identify trends, measure the effectiveness of scheduling strategies, and/or make informed decisions for continuous improvement.

The user interface 736 allows branch managers, technicians, and other stakeholders to view schedules, report statuses, and resource requirements. The user interface 736 may include features such as interactive maps for visualizing site locations and scheduling calendars for managing tasks.

Security and authentication 738 ensure data integrity and protect sensitive information. Security and authentication 738 may include security measures such as encryption, access controls, and user authentication mechanisms.

Referring now to FIGS. 8-14, information included in a report is shown, according to an exemplary embodiment. The report may be a report generated for a service technician by the report generator 724. The report may be for a plurality of pieces of equipment at a site or specific piece of equipment at the site.

FIGS. 8-10 illustrates components of a first section 800 of the report. The first section 800 may be an executive summary including elements summarizing the performance of one or more pieces of equipment at a site. For example, referring now to FIG. 8, section 802 is a chart indicating run hours for a plurality of pieces of equipment. The chiller run hours table 802 may display, for example, a name of the equipment, and a model and/or serial number for the equipment. The chiller run hours table 802 may also include a number of hours the equipment has run in its lifetime, as well as a number of times or hours the equipment has been started and/or stopped. Section 804 of the executive summary 800 may be a table indicating, in greater detail, the run hours of pieces of equipment. For example, table 804 may include, for each month, run hours and stop/start hours for each piece of equipment. Section 806 of the summary may indicate an equipment performance index. For example, an equipment performance index may be a numerical value that is an aggregate of equipment data for a piece of equipment. The performance index may be indicative of performance, reliability, and/or efficiency of the equipment. The performance index may indicate that the performance of the equipment is acceptable, in an alert state (e.g., the equipment may be or will, in the future, be performing poorly), or an alarm state (e.g., the equipment needs servicing). The equipment performance index may indicate performance on a per-month basis. In some embodiments, the equipment performance index may be generated using the techniques described in U.S. Pat. No. 11,630,453 granted Apr. 18, 2023, the entire disclosure of which is incorporated by reference herein.

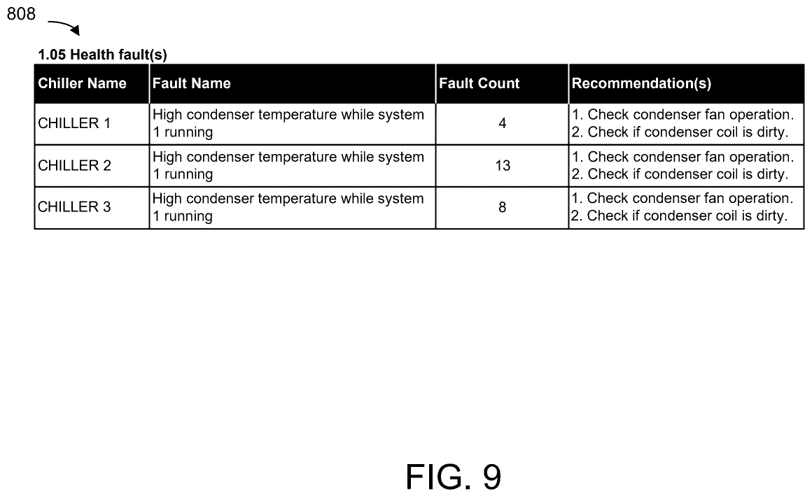

FIG. 9 illustrates a section 808 of summary 800. Section 808 may be or include one or more health faults of a piece of equipment. Section 808 may include an identifier of the equipment (e.g., name). Section 808 may also include a fault name. The name of the fault may be a brief description of the issue experienced by the equipment. A fault count may indicate a number of times the system or equipment has recognized this fault. Section 808 may also include one or more recommendations for servicing the equipment to resolve the fault.

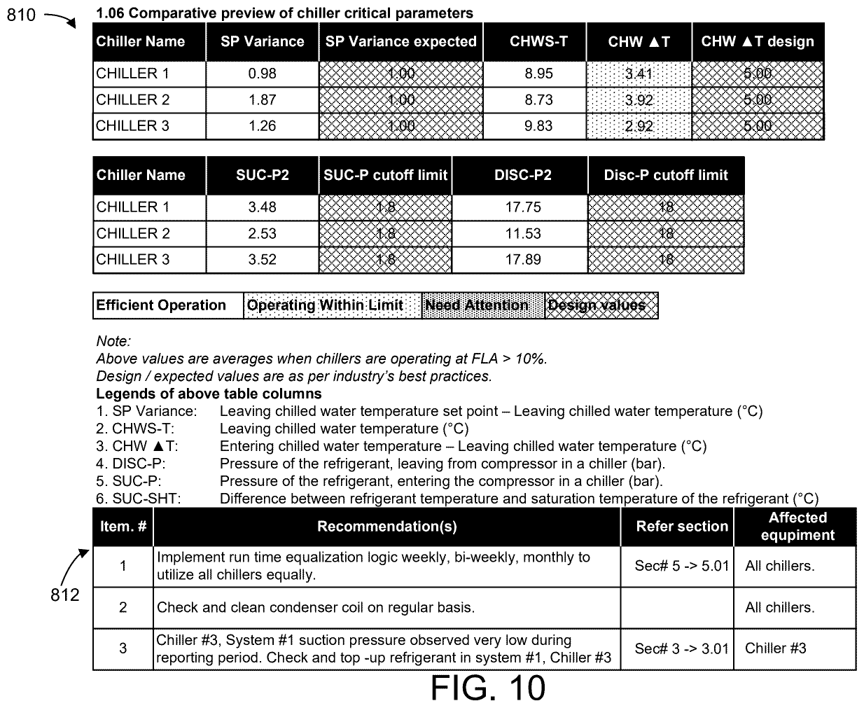

FIG. 10 illustrates a section 810 of summary 800. Section 810 may be or include a comparative preview of critical parameters for a plurality of pieces of equipment. For example, the preview may include an actual setpoint variance, a chilled water temperature, a refrigerant pressure, etc. Each value may be color-coded to indicate if the value indicates that the equipment is operating efficiently, operating within a predefined limit, or needs attention. The table may also include design or expected values for each parameter. Section 810 may also include a recommendation table 812. The recommendation table 812 may indicate, for the equipment as a whole or for individual pieces of equipment, a recommendation to resolve an issue or sub-optimal performance. The recommendation table 812 may further include a reference to a section of a handbook for the equipment for guidance on executing the recommendations.

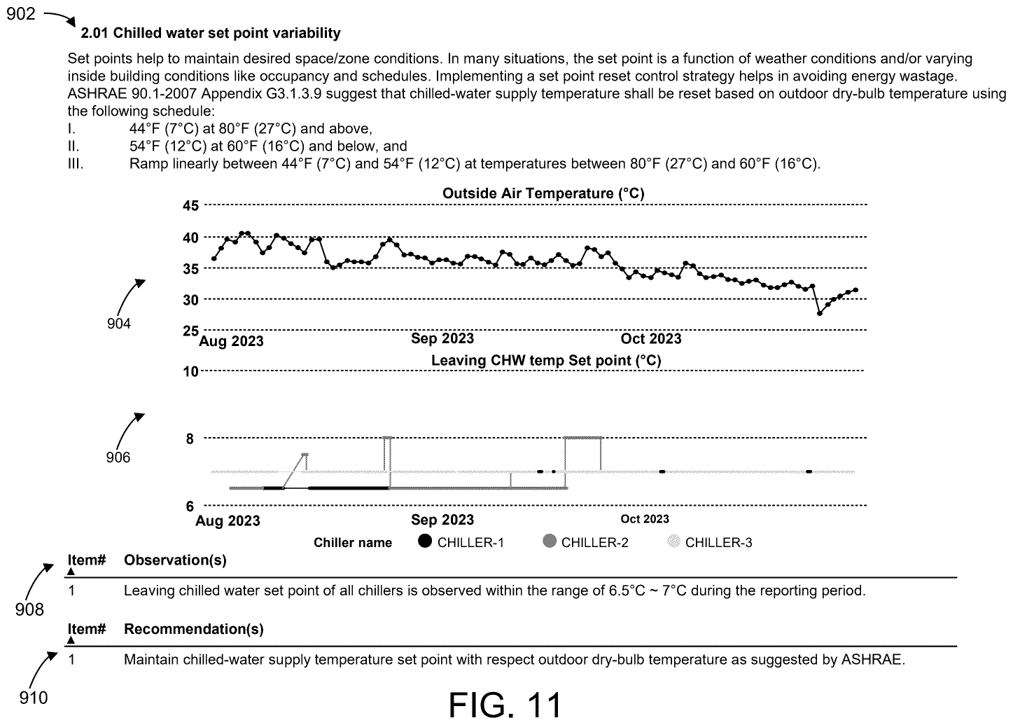

Referring now to FIG. 11, a second section 900 of an exemplary report is shown. Section 900 may be, for example, indicative of a chilled water setpoint, variability, and delivery of a piece of equipment. Section 902 of the section 900 may provide information on the setpoint variability. Plot 904 may indicate, respectively, an outside air temperature at the site of the piece(s) of equipment. Plot 906 may indicate a setpoint temperature for water leaving a chiller. Item 908 may indicate an observation generated responsive to the trends in the plots 904 and 906. Item 910 may indicate one or more recommendations to take to repair the equipment. The recommendations may be based on the observations 908. In various embodiments, the section 900 may include one or more plots indicating additional variables, such as a chilled water setpoint and delivery.

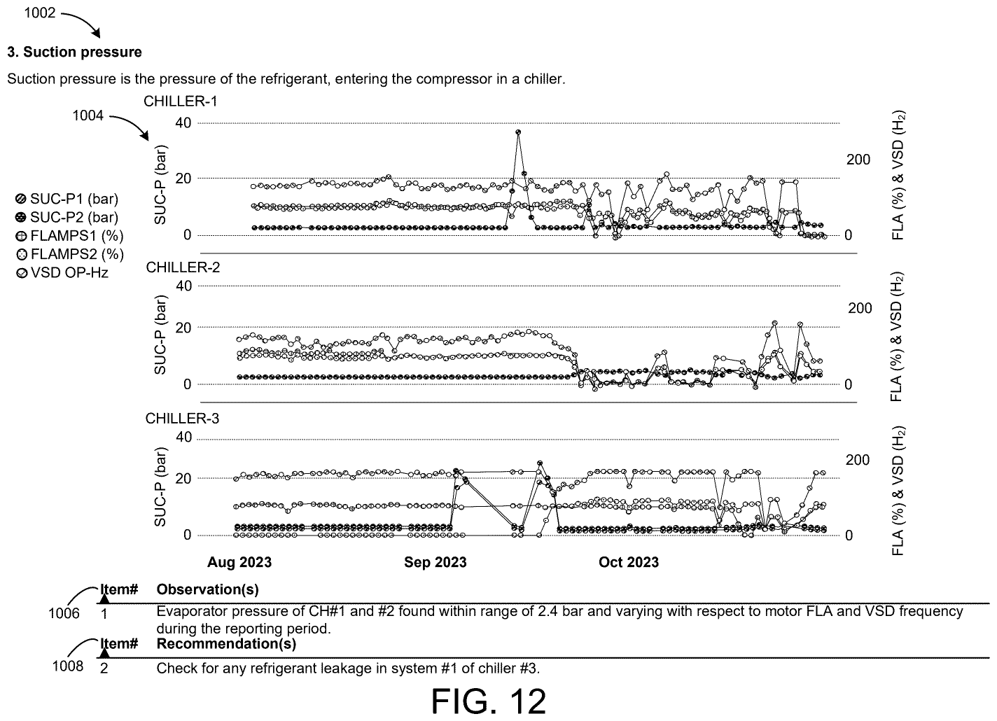

Referring now to FIG. 12, a third section 1000 of an exemplary report is shown. Section 1000 may include a section 1002 indicative of a suction pressure of a piece of equipment. Section 1002 of the section 1000 may provide information on the suction pressure of refrigerant entering a piece of equipment. Plots 1004 may indicate, respectively, suction pressure for each piece of equipment at a site. Item 1006 may indicate an observation generated responsive to the trends in the plots 1004. Item 1008 may indicate one or more recommendations to take to repair the chiller. The recommendations may be based on the observations 1006.

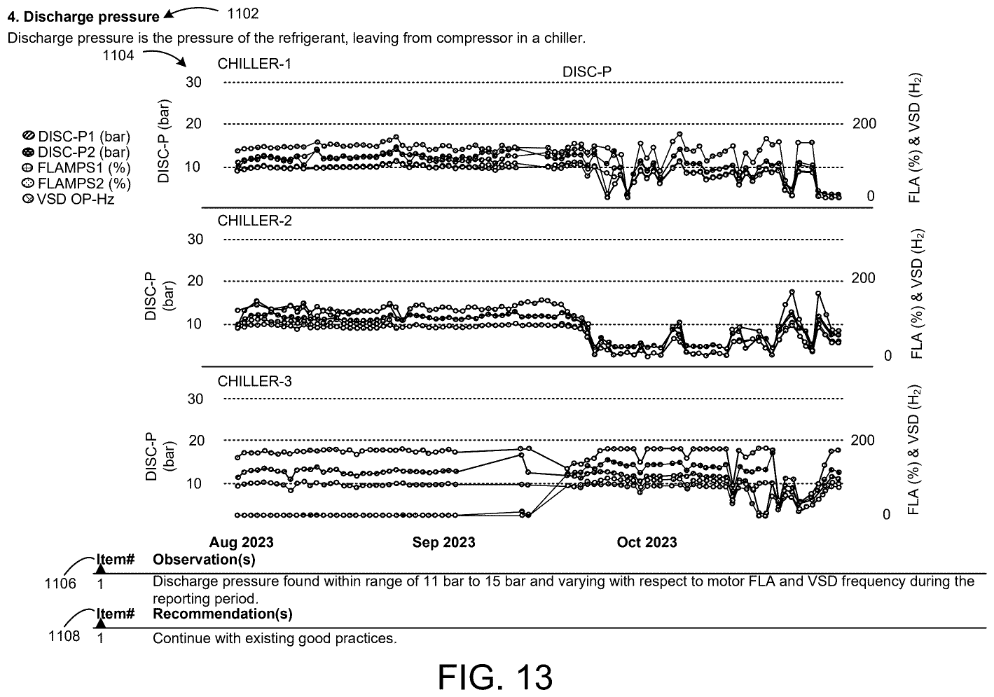

Referring now to FIG. 13, a fourth section 1100 of an exemplary report is shown. Section 1100 may include a section 1102 indicative of a discharge pressure of a piece of equipment. Section 1002 of the section 1000 may provide information on the suction pressure of refrigerant leaving a piece of equipment. Plots 1104 may indicate, respectively, discharge pressure for each piece of equipment at a site. Item 1106 may indicate an observation generated responsive to the trends in the plots 1104. Item 1108 may indicate one or more recommendations to take to repair the chiller. The recommendations may be based on the observations 1106.

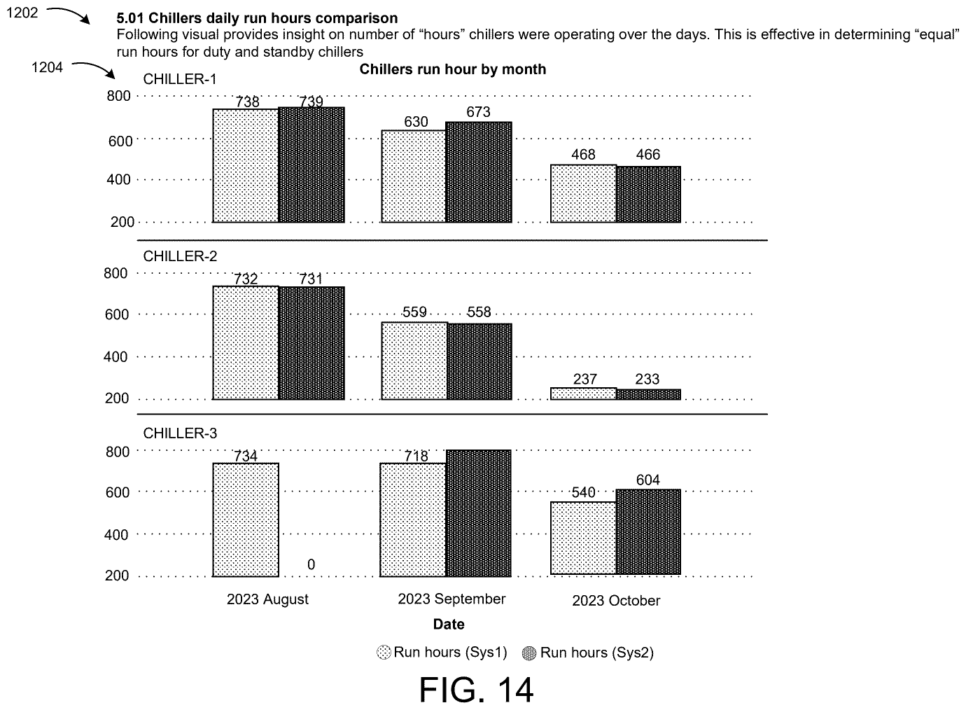

Referring now to FIG. 14, a fifth section 1200 of an exemplary report is shown. Section 1200 may include, for example, information relating to an equalization analysis for a runtime of a piece of equipment. Section 1202 of the section 900 may provide a comparison of daily run hours for pieces of equipment. Plots 1204 may indicate, for each piece of equipment, a month-to-month comparison of run time hours for a piece of equipment. In various embodiments, a piece of equipment may belong to a plurality of systems. The plots 1204 may indicate how many hours a piece of equipment is spent running for each system it belongs to.

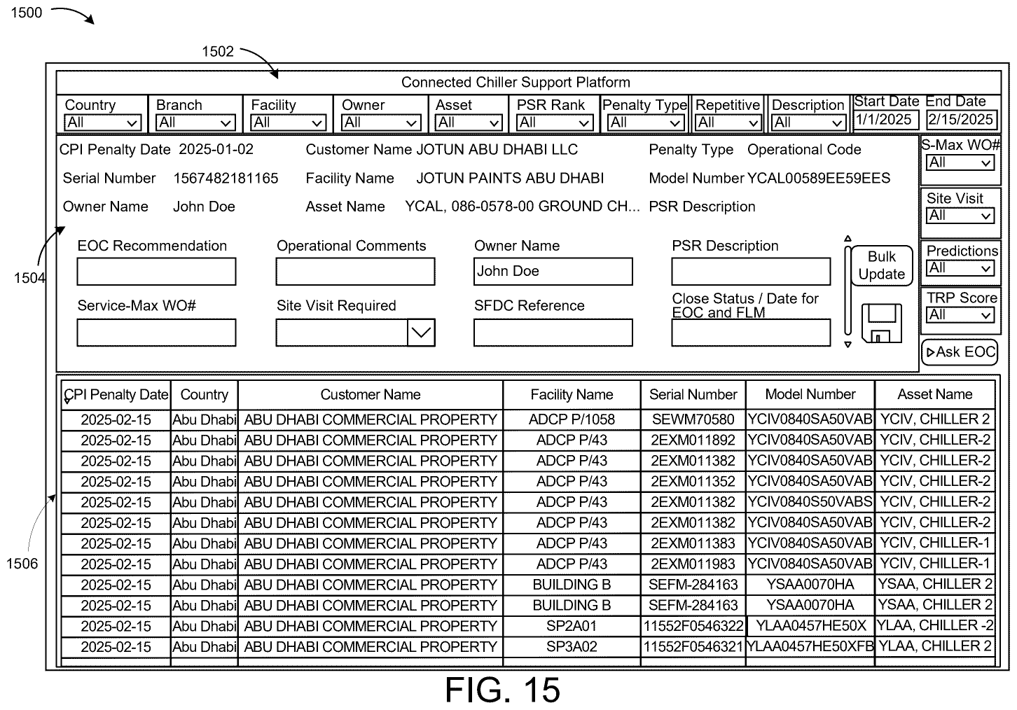

Referring now to FIG. 15, a user interface 1500 is shown, according to an example embodiment. The user interface 1500 may include information generated and included in the service report described with respect to FIGS. 8-14.

As shown, a service technician may view the user interface 1500 and apply one or more filters 1502 to identify different equipment faults. For example, the user may filter to view results (e.g., equipment) by country, by branch, by facility, by owner, by asset tyle, by a PSR rank, by a penalty type, by repetition, by description, by a start date, and/or by an end date.

The user interface 1500 may include a first portion 1504 that includes information about a particular piece of building equipment and a particular fault. For example, the first portion 1504 may include a date of a fault, information about the piece of building equipment (e.g., serial number, model number, name, an owner of the equipment, a name of a customer, a name of a facility at which the equipment is located, etc.). The first portion 1504 may also include one or more text boxes. A service technician may enter comments or other textual information into the one or more text boxes.

For example, the service technician may include a description of a proactive service recommendation (PSR), operational comments, a work order number, an indication of whether an on-site visit is requested, etc. The technician can submit the information to update a user interface corresponding to a particular piece of equipment and/or a particular fault.

The user interface 1500 also includes a second portion 1506. The second portion 1506 includes a chart, table, listing, etc. of faults associated with a particular fault and/or piece of building equipment. The second portion 1506 may update to include an additional entry responsive to the user entering text into the text boxes in the first portion 1504 of the user interface. For example, upon entering and submitting data in the first portion 1504, the data may be included in the second portion 1506.

The user interface 1500 may allow a user (e.g., service technician) to view relevant information about the particular piece of building equipment. In addition to the information described above, the user interface may include information indicative of a future or predicted fault that may be experienced by the piece of building equipment. For example, the user interface 1500 may include sensor information indicating that the equipment may experience a fault within a predicted or predetermined time frame, thereby allowing a user to proactively service the building equipment and prevent a fault. As such, if a service technician were to be dispatched to service a piece of building equipment to fix an existing fault or error, the user could also perform maintenance during the same visit to proactively address the cause of the predicted or upcoming fault, thereby preventing the user from having to be dispatched to service the equipment for a second time.

In some embodiments, the user interface 1500 may also include current data, such as live sensor readings indicating a current performance of the piece of building equipment and/or historical data. In this manner, the user interface 1500 may provide a historical record of service for the building equipment, previous faults, etc.

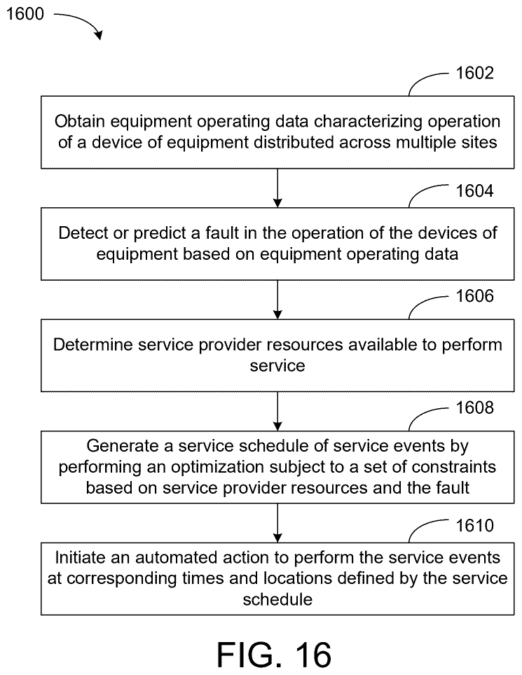

Referring now to FIG. 16, a flow diagram is shown for a method 1600. The method 1600 may be for optimizing a service schedule based on both available remote and on-site service provider resources.

At step 1602, equipment operating data is obtained. The equipment operating data may be obtained by the maintenance scheduling and optimization system 502. The equipment operating data may characterize operation of a plurality of devices of equipment. The plurality of devices of equipment may be distributed across a plurality of equipment sites.

At step 1604, a plurality of faults in the operation of the plurality of devices of equipment may be determined or predicted. The plurality of faults may be based on the equipment operating data. The maintenance scheduling and optimization system 502 may determine the plurality of faults. In various embodiments, detecting or predicting the plurality of faults includes gathering additional data from an equipment site to diagnose a root cause of a detected or predicted fault. The root cause evaluator 722 may diagnose a root cause of the fault.

At step 1606, the resource manager 726 may determine service provider resources available to perform service on the plurality of devices of equipment. The service provider resources may include remote service provider resources and on-site service provider resources. The resources may be determined responsive to a determination that the service event requires a remote or on-site technician. In various embodiments, the service provider resources include times of availability and expertise of a plurality of service technicians. In various embodiments, the service provider resources may vary by geographic region and indicate at least one of different numbers of service technicians, different levels of expertise of the service technicians, or different tools or parts available to the service technicians based on the geographic region in which the fault is detected or predicted. In various embodiments, the service provider resources include one or more vehicles or tools used to perform the plurality of service activities.

At step 1608, generating a service schedule is generated by the schedule optimizer 730. The service schedule may include a plurality of service events based on the plurality of faults and the service provider resources determined in steps 1604 and 1606, respectively. The service schedule may be generated responsive to the faults and the service provider resources being determined. The plurality of service events may include at least one remote service event using the remote service provider resources and at least one on-site service event using the on-site service provider resources. The service schedule may be generated by performing an optimization. Performing the optimization may include assigning one or more vehicles or tools to the plurality of service events.

The optimization may be subject to a set of constraints based on the service provider resources and the plurality of faults. In various embodiments, the set of constraints includes a limit or penalty based on a travel time or travel distance between the plurality of service events in the service schedule. The constraints may also include amounts of time and expertise required to perform the corresponding service activities. The optimization may include optimizing an objective function that quantifies a total value of the plurality of service events based on at least one of (i) corresponding criticalities of the plurality of faults or (ii) corresponding amounts of time elapsed between times at which the plurality of faults are detected and the times defined by the plurality of service events.

In various embodiments, generating the service schedule may include classifying the plurality of faults as either (i) remote fix faults capable of being fixed remotely by remote service technicians or (ii) on-site fix faults requiring on-site service technicians to travel to the equipment sites to perform the service activities. The fault classifier 720 may classify the plurality of faults.

At step 1608, an automated action is initiated. The automated action may be to perform the service activities at the corresponding times and locations defined by the service schedule. The schedule optimizer 730 may initiate the automated action responsive to the service scheduling being generated. In various embodiments, initiating the automated action may include causing one or more service technicians to perform the plurality of service activities defined by the service schedule. In various embodiments, the automated action may include distributing at least a portion of the service schedule to a plurality of technicians assigned to the plurality of service events. In various embodiments, the automated action includes taking action to resolve the fault remotely.

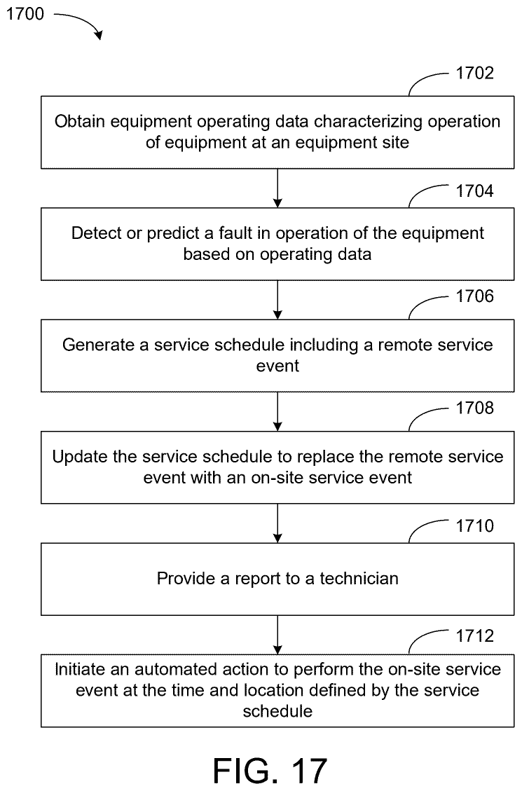

Referring now to FIG. 17, a flow diagram is shown for a method 1700. The method 1700 may be for attempting a remote fix of a service issue before attempting an on-site fix and providing reports to on-site service technicians.

At step 1702, equipment operating data is obtained. The equipment operating data may characterize operation of equipment located at an equipment site. The equipment operating data may be obtained by the maintenance scheduling and optimization system 502.

At step 1704, a fault in the operation of the equipment may be determined or predicted. The plurality of faults may be based on the equipment operating data. The maintenance scheduling and optimization system 502 may determine the plurality of faults. In various embodiments, detecting or predicting the plurality of faults includes gathering additional data from an equipment site to diagnose a root cause of a detected or predicted fault. The root cause evaluator 722 may diagnose a root cause of the fault.

At step 1706, a service schedule is generated by the schedule optimizer 730. The service schedule may include a remote service event. The remote service event may include assigning a remote service technician to attempt to fix the fault remotely. The service schedule may be generated by performing an optimization. Performing the optimization may include assigning one or more vehicles or tools to the plurality of service events.

The optimization may be subject to a set of constraints based on service provider resources and the plurality of faults. The constraints may include amounts of time and expertise required to perform the corresponding service activities. The optimization may include optimizing an objective function that quantifies a total value of the plurality of service events based on at least one of (i) corresponding criticalities of the plurality of faults or (ii) corresponding amounts of time elapsed between times at which the plurality of faults are detected and the times defined by the plurality of service events.

At step 1708, the service schedule is updated to replace the remote service event with an on-site service event. The schedule optimizer 730 may perform the schedule update and replace the remote service event responsive to the remote service event failing to fix the fault.

At step 1710, a report is provided to an on-site service technician. The report may be provided prior to a time defined by the on-site service event. The report may be generated by the report generator 724 responsive to an indication that the remote service event did not resolve the fault. In various embodiments, the report may identify a history of prior service events for the equipment, including the remote service event.

At step 1712, an automated action is initiated. The automated action may be to perform the on-site service event at the location of the equipment at the time defined by the service schedule. The schedule optimizer 730 may initiate the action responsive to the schedule being updated. In various embodiments, initiating the automated action may include causing one or more service technicians to perform the plurality of service activities defined by the service schedule. In various embodiments, the automated action may include distributing at least a portion of the service schedule to a plurality of technicians assigned to the plurality of service events.

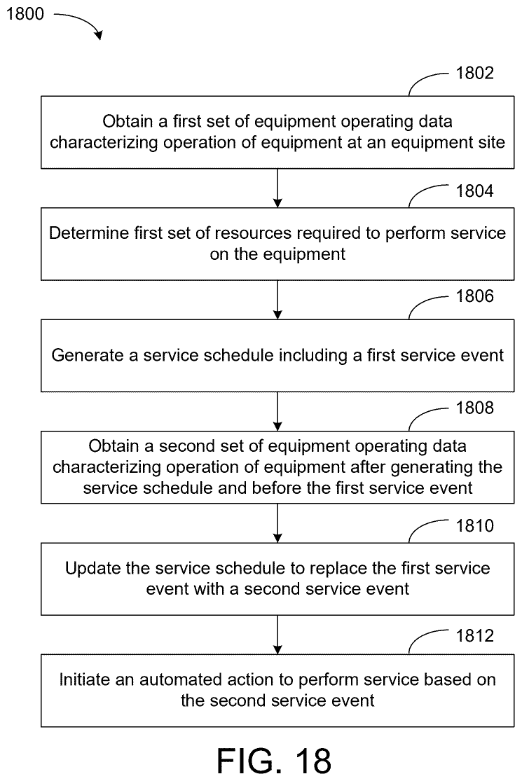

Referring now to FIG. 18, a flow diagram is shown for a method 1800. The method 1800 may be for dynamically updating a service schedule in response to new operating data from equipment indicating different service requirements.

At step 1802, a first set of equipment operating data is obtained. The first set of equipment data may characterize operation of equipment located at an equipment site. The equipment operating data may be obtained by the maintenance scheduling and optimization system 502.

At step 1804, a first set of service provider resources is determined. The first set of service provider resources may be required to perform service on the equipment based on the first set of equipment operating data. The first set of service provider resources may include remote service provider resources and on-site service provider resources. The resources may be determined responsive to a determination that the service event requires a remote or on-site technician. In various embodiments, the service provider resources may include times of availability and expertise of a plurality of service technicians. In various embodiments, the service provider resources may vary by geographic region and indicate at least one of different numbers of service technicians, different levels of expertise of the service technicians, or different tools or parts available to the service technicians based on the geographic region in which the fault is detected or predicted. In various embodiments, the service provider resources include one or more vehicles or tools used to perform the plurality of service activities.

At step 1806, a service schedule is generated. The service schedule may include a first service event which uses the first set of service provider resources to perform the service on the equipment;

At step 1808, a second set of equipment operating data characterizing the operation of equipment is obtained. The second set of equipment operating data may be obtained after generating the service schedule and before the first service event.

At step 1810, the service schedule is updated to replace the first service event with a second service event. The second service event may use a second set of service provider resources to perform the service on the equipment. The service schedule may be updated in response to the second set of equipment operating data indicating different service requirements than the first set of equipment operating data.

At step 1812, an automated action is initiated to perform service on the equipment in accordance with the second service event. The automated action may be to perform the service in accordance with the second service event at the corresponding times and locations defined by the service schedule. The schedule optimizer 730 may initiate the automated action responsive to the service scheduling being updated. In various embodiments, initiating the automated action may include causing one or more service technicians to perform the plurality of service activities defined by the service schedule. In various embodiments, the automated action may include distributing at least a portion of the service schedule to a plurality of technicians assigned to the plurality of service events. In various embodiments, the automated action includes taking action to resolve the fault remotely.

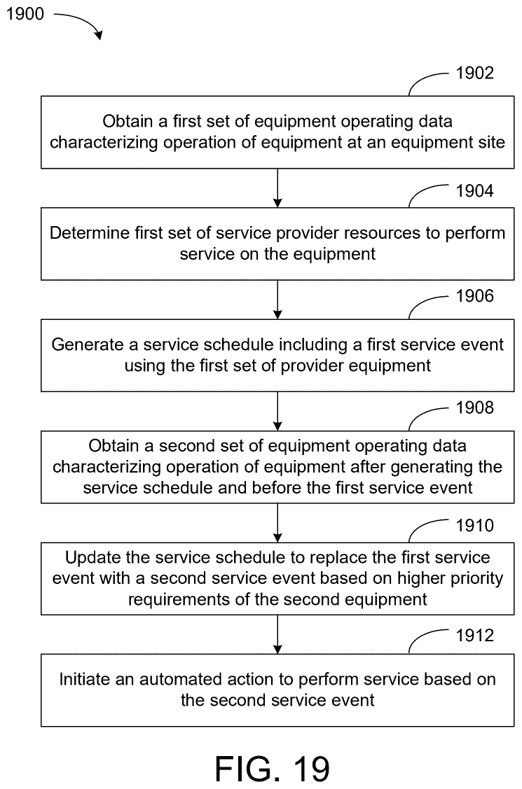

Referring now to FIG. 19, a flow diagram is shown for a method 1900. The method 1900 may be for dynamically updating service schedule in response to new operating data from different equipment indicating higher priority service events.

At step 1902, a first set of equipment operating data is obtained. The first set of equipment operating data may characterize operation of first equipment located at an equipment site.

At step 1904, a first set of service provider resources is determined. The first set of service provider resources may be resources required to perform service on the equipment based on the first set of equipment operating data.

At step 1906, a service schedule is generated. The service schedule may include a first service event. The first service event may use the first set of service provider resources to perform the service on the equipment.

At step 1908, a second set of equipment operating data is obtained. The second set of equipment operating data may characterize operation of second equipment. The second set of equipment operating data may be obtained after generating the service schedule and before the first service event.

At step 1910, the service schedule may be updated to replace the first service event with a second service event. The second service event may use a second set of service provider resources to perform the service on the first equipment. The second service event may be performed in response to the second set of equipment operating data indicating higher priority service requirements associated with the second equipment.

At step 1912, an automated action to perform service on the first equipment in accordance with the second service event is initiated. The automated action may be to perform the service in accordance with the second service event at the corresponding times and locations defined by the service schedule. The schedule optimizer 730 may initiate the automated action responsive to the service scheduling being updated. In various embodiments, initiating the automated action may include causing one or more service technicians to perform the plurality of service activities defined by the service schedule. In various embodiments, the automated action may include distributing at least a portion of the service schedule to a plurality of technicians assigned to the plurality of service events. In various embodiments, the automated action includes taking action to resolve the fault remotely.

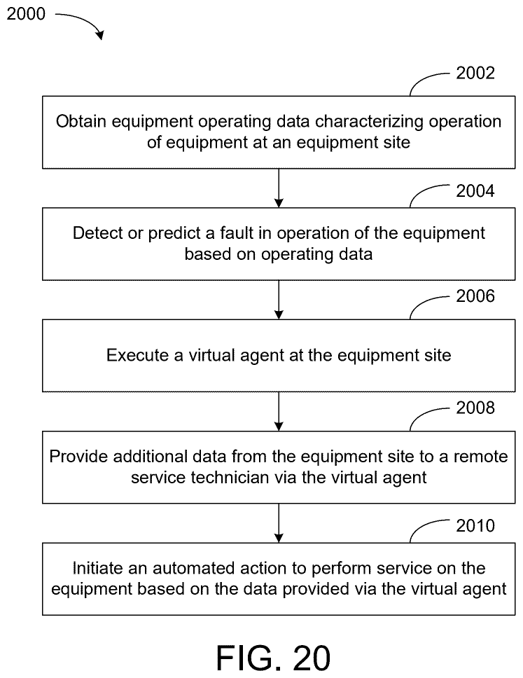

Referring now to FIG. 20, a flow diagram is shown for a method 2000. The method 2000 may be for utilizing an on-site GAI or virtual agent which communicates with remote technician to gather data required for FDD or to provide service.

At step 2002, equipment operating data is obtained. The equipment operating data may characterize operation of equipment located at an equipment site.

At step 2004, a fault in the operation of the equipment may be predicted or detected. The fault may be predicted or detected based on or responsive to receiving the equipment operating data. The faults may be based on the equipment operating data. The maintenance scheduling and optimization system 502 may determine the fault. In various embodiments, detecting or predicting the fault includes gathering additional data from an equipment site to diagnose a root cause of a detected or predicted fault. The root cause evaluator 722 may diagnose a root cause of the fault.

At step 2006, a virtual agent is executed. The virtual agent may be executed at the equipment site. The virtual agent may gather additional data for use in diagnosing a cause of the fault or repairing the fault.

At step 2008, the additional data from the equipment site is provided to a remote service technician via the virtual agent.

At step 2010, an automated action to perform service on the equipment is initiated. The automated action may be based on the additional data provided via the virtual agent.

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements can be reversed or otherwise varied and the nature or number of discrete elements or positions can be altered or varied. Accordingly, all such modifications are intended to be included within the scope of the present disclosure. The order or sequence of any process or method steps can be varied or re-sequenced according to alternative embodiments. Other substitutions, modifications, changes, and omissions can be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure can be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps can be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method comprising:
obtaining equipment operating data characterizing operation of a plurality of devices of equipment distributed across a plurality of equipment sites;
detecting or predicting a plurality of faults in the operation of the plurality of devices of equipment based on the equipment operating data;
determining service provider resources available to perform service on the plurality of devices of equipment, the service provider resources comprising remote service provider resources and on-site service provider resources;
generating a service schedule comprising a plurality of service events based on the plurality of faults and the service provider resources, the plurality of service events comprising at least one remote service event using the remote service provider resources and at least one on-site service event using the on-site service provider resources, wherein the service schedule is generated by performing an optimization subject to a set of constraints based on the service provider resources and the plurality of faults; and
initiating an automated action to perform the plurality of service events at corresponding times and locations defined by the service schedule.

2. The method of claim 1, wherein the plurality of equipment sites comprise a building site and the equipment comprise HVAC equipment located at the building site.

3. The method of claim 1, wherein initiating the automated action comprises causing one or more service technicians to perform the plurality of service events defined by the service schedule.

4. The method of claim 1, wherein initiating the automated action comprises distributing at least a portion of the service schedule to a plurality of technicians assigned to the plurality of service events.

5. The method of claim 1, wherein generating the service schedule comprises classifying the plurality of faults as either (i) remote fix faults capable of being fixed remotely by remote service technicians or (ii) on-site fix faults requiring on-site service technicians to travel to the equipment sites to perform the plurality of service events.

6. The method of claim 1, wherein the automated action comprises taking action to resolve the fault remotely.

7. The method of claim 1, wherein detecting or predicting the plurality of faults comprises gathering additional data from an equipment site to diagnose a root cause of a detected or predicted fault.

8. The method of claim 1, wherein the set of constraints comprises a limit or penalty based on a travel time or travel distance between the plurality of service events in the service schedule.

9. The method of claim 1, wherein the optimization comprises optimizing an objective function that quantifies a total value of the plurality of service events based on at least one of (i) corresponding criticalities of the plurality of faults or (ii) corresponding amounts of time elapsed between times at which the plurality of faults are detected and the times defined by the plurality of service events.

10. The method of claim 1, wherein (i) the service provider resources comprise times of availability and expertise of a plurality of service technicians and (ii) the constraints comprise amounts of time and expertise required to perform the corresponding service events.

11. The method of claim 1, wherein the service provider resources vary by geographic region and indicate at least one of different numbers of service technicians, different levels of expertise of the service technicians, or different tools or parts available to the service technicians based on the geographic region in which the fault is detected or predicted.

12. The method of claim 1, wherein (i) the service provider resources comprise one or more vehicles or tools used to perform the plurality of service events and (ii) performing the optimization comprises assigning the one or more vehicles or tools to the plurality of service events.

13. A method comprising:
obtaining equipment operating data characterizing operation of equipment located at an equipment site;
detecting or predicting a fault in the operation of the equipment based on the equipment operating data;
generating a service schedule comprising a remote service event based on the fault, the remote service event assigning a remote service technician to attempt to fix the fault remotely;
updating the service schedule to replace the remote service event with an on-site service event in response to the remote service event failing to fix the fault;
providing a report to an on-site service technician prior to a time defined by the on-site service event, the report identifying a history of prior service events for the equipment including the remote service event; and
initiating an automated action to perform the on-site service event at the location of the equipment at the time defined by the service schedule.

14. The method of claim 13, wherein initiating the automated action comprises causing one or more service technicians to perform the on-site service event defined by the service schedule.

15. The method of claim 13, wherein initiating the automated action comprises distributing at least a portion of the service schedule to a plurality of technicians assigned to the on-site service event.

16. The method of claim 13, wherein detecting or predicting the fault comprises gathering additional data from an equipment site to diagnose a root cause of a detected or predicted fault.

17. The method of claim 13, comprising optimizing an objective function that quantifies a total value of the on-site service event based on at least one of (i) corresponding criticalities of the fault or (ii) corresponding amounts of time elapsed between times at which the fault is detected and the times defined by the on-site service event.

18. A method comprising:
obtaining a first set of equipment operating data characterizing operation of equipment located at an equipment site;
determining a first set of service provider resources required to perform service on the equipment based on the first set of equipment operating data;
generating a service schedule comprising a first service event which uses the first set of service provider resources to perform the service on the equipment;
obtaining a second set of equipment operating data characterizing the operation of equipment after generating the service schedule and before the first service event;
updating the service schedule to replace the first service event with a second service event which uses a second set of service provider resources to perform the service on the equipment in response to the second set of equipment operating data indicating different service requirements than the first set of equipment operating data; and
initiating an automated action to perform service on the equipment in accordance with the second service event.

19. The method of claim 18, wherein initiating the automated action comprises at least one of: causing one or more service technicians to perform the second service event defined by the service schedule, distributing at least a portion of the service schedule to a plurality of technicians assigned to the plurality of service events, or taking action to perform the service on the equipment remotely.

20. The method of claim 18, wherein the second set of equipment operating data characterizes operation of second equipment, the second equipment different from the first equipment, and wherein the method further comprises:
updating the service schedule to replace the first service event with a second service event which uses a second set of service provider resources to perform the service on the equipment in response to the second set of equipment operating data indicating higher priority service requirements associated with the second equipment.
